(19) United States
(12) Patent Application Publication
(10) Pub. No.: US 2021/0246256 A1
(43) Pub. Date: Aug. 12, 2021

(54) POLYURETHANE FOAM OR POLYETHER POLYOL STABILIZED WITH A BENZOFURANONE-PHOSPHITE DERIVATIVE

(71) Applicant: BASF SE, Ludwigshafen am Rein (DE)

(72) Inventors: Cinzia Tartarini, Pontecchio Marconi BO (IT); Werner Hoelzl, III, Eschentzwiller (FR); Roswell E. King, III, Tarrytown, NY (US); Heinz Herbst, Kaisten (CH); Jorge Espinos Arizti, Barcelona (ES)

(21) Appl. No.: 16/973,477

(22) PCT Filed: Jun. 20, 2019
(86) PCT No.: PCT/EP2019/066377

§ 371 Date: Dec. 9, 2020

(30) Foreign Application Priority Data
Jun. 28, 2018 (EP) 18382482.0

(51) Int. Cl. C08G 18/76; C08G 18/48; C08K 5/00; C08K 5/18; C08K 5/134; C08K 5/529

(52) U.S. Cl. CPC C08G 18/7621; C08G 18/4829; C08K 5/005; C08K 5/18; C08G 2110/0066; C08K 5/529; C08G 2110/005; C08G 2110/0058; C08K 5/134

(57) ABSTRACT

The invention relates to a composition, which comprises the components (a) a polyurethane foam or a polyether polyol; and (b) a compound of formula (I) wherein R¹ is H or C₁-alkyl. A process for manufacturing the aforementioned composition, the use of a component (b) for stabilizing component (a) against degradation and a specific additive mixture comprising component (b) and as component (c) a first further additive, which is a specific aromatic amine, are described.

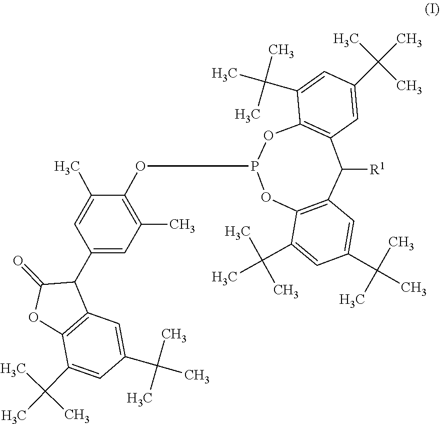

The current invention relates to a composition comprising a polyurethane foam or a polyether polyol as component (a) and a specific benzofuranone-phosphite derivative as component (b). A process for manufacturing the aforementioned composition, the use of the specific benzofuranone-phosphite derivative for stabilizing the component (a) and a specific additive mixture comprising the specific benzofuranone-phosphite derivative and a phenylarylamine are addressed.

Polyurethane foam is commonly used as a material in application areas like home furniture, automotive interior or construction. These are application areas, in which long-lasting operation times of the employed materials are desired. This might be contrasted to the application area of packaging in case of one-time packaging for protection of packaged goods against a mechanical shock. Like many organic materials, polyurethane itself and particularly polyurethane foam is susceptible to degradation caused by exposure to energy or chemically reactive species. There is on one side already the initial exothermic reaction of the starting materials polyol and di- or polyisocyanates forming the polyurethane foam itself and on the other side the long-term exposure towards heat and/or light during its operating time. The initial exothermic reaction of the starting materials for the polyurethane foam is conducted under conditions, where a foaming agent generates a blowing gas. In case of water as a foaming agent, the reaction with an isocyanate for releasing carbon dioxide is additionally exothermic. A polyether polyol is often used as a polyol starting material of a polyurethane foam, if a polyurethane foam with a soft foam consistency is desired. A polyether polyol is itself already an organic material susceptible to degradation caused by exposure to energy or chemically reactive species. If a polyether polyol is employed already in a marred state as a starting material for a polyurethane foam, then this is not beneficial for resistance of the formed polyurethane foam against future exposure to energy or chemically reactive species.

EP 1291384 A discloses the application of a benzofuranone substituted with an acetoxy-substituted phenyl as depicted below as a stabilizer of a polyurethane foam based on a polyether polyol. It is found superior regarding discoloration of the stabilized foam versus a comparative benzofuranone substituted with a phenyl, which is solely substituted by two C-alklyl groups, as depicted below.

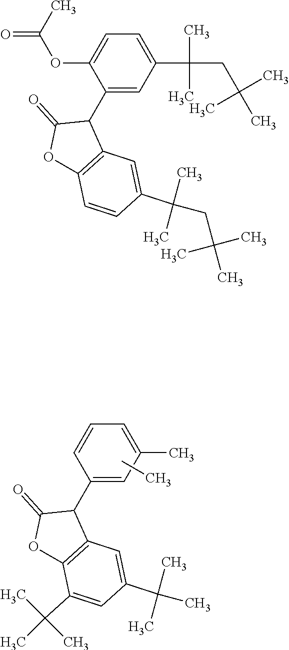

WO 2006/065829 A discloses the application of a benzofuranone substituted with a benzofuranone substituted with an alkoxy-substituted phenyl, a main component of it as depicted below, as a stabilizer of a polyurethane foam based on a polyether polyol. It is found superior or equal versus a comparative benzofuranone substituted with a phenyl, which is substituted by two C-alklyl groups as depicted below. Furthermore, both benzofuranones are applied as stabilizer of a polyether polyol and a similar performance is described for both.

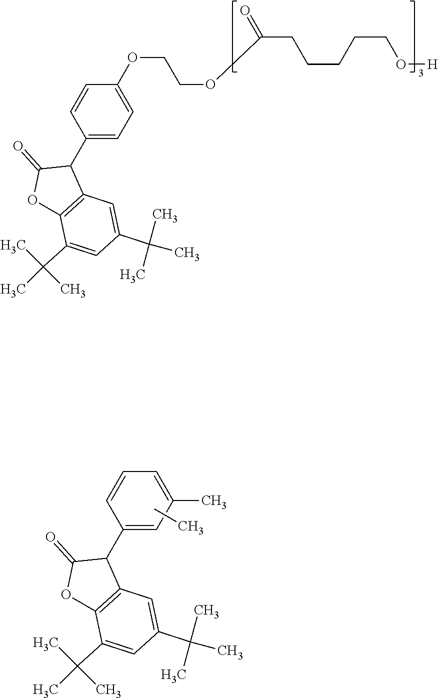

WO 2015/121445 A discloses benzofuranone phosphite derivatives as a stabilizer for organic materials susceptible to oxidative, thermal or light-induced degradation. Out of 9 disclosed specific benzofuranone phosphites, 8 are applied for stabilization of polyethylene or polypropylene in the examples. Inter alia, two specific mono-benzofuranone phosphites as depicted below are employed.

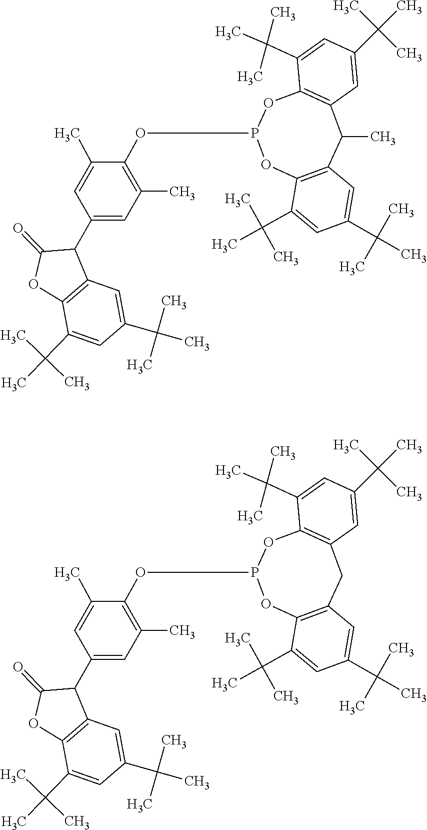 [SMILES: Cc1cc(C2C(=O)Oc3c2cc(C(C)(C)C)cc3C(C)(C)C)cc(C)c1OP1Oc2c(cc(C(C)(C)C)cc2C(C)(C)C)C(C)c2cc(C(C)(C)C)cc(C(C)(C)C)c2O1 ; Cc1cc(C2C(=O)Oc3c2cc(C(C)(C)C)cc3C(C)(C)C)cc(C)c1OP1Oc2c(cc(C(C)(C)C)cc2C(C)(C)C)Cc2cc(C(C)(C)C)cc(C(C)(C)C)c2O1]

WO 2017/025431 A discloses benzofuranone phosphate derivatives as stabilizers for organic materials susceptible to oxidative, thermal or light-induced degradation. Examples show the stabilization of polyethylene and polypropylene with a specific benzofuranone phosphate derivative. This specific benzofuranone phosphate is also shown to be more resistant towards exposure of humidity than its specific benzofuranone phosphite counterpart. Another specific benzofuranone phosphate is also disclosed and depicted below.

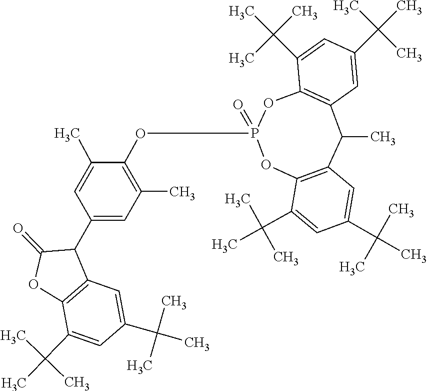 [SMILES: Cc1cc(C2C(=O)Oc3c2cc(C(C)(C)C)cc3C(C)(C)C)cc(C)c1OP1(=O)Oc2c(cc(C(C)(C)C)cc2C(C)(C)C)C(C)c2cc(C(C)(C)C)cc(C(C)(C)C)c2O1]

Despite of a series of already available stabilizer concepts, there is still a need for further technical concepts towards an improved stabilization of a polyurethane foam or a polyether polyol against the detrimental impact of heat, light and/or oxidation. Preferably, the technical concept allows a simplified handling during its application.

It is an object of the present invention to provide an improved stabilization against the detrimental impact of heat, light and/or oxidation. Particularly, a good resistance against oxidation by oxygen is desired. Particularly, a good resistance against scorching, which is a degradation observed at a material in the form of a foam, is desired.

The object is achieved, according to the invention, by a composition, which comprises the components
(a) a polyurethane foam or a polyether polyol; and
(b) a compound of formula I

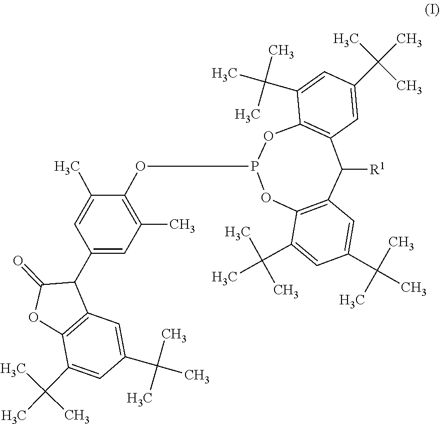

wherein R¹ is H or C₁-alkyl.

A compound of formula I possesses at least one asymmetric carbon atom, i.e. a carbon atom at the 3-position of the benzofuran-2-one structural unit. A further asymmetric carbon atom is present in case R¹ is C₁-alkyl. A phosphorus atom, which is substituted with three different substituents, can show a hindered inversion, which can lead dependent on temperature to an asymmetric phosphorus atom. The invention relates to any one of these enantiomers, resulting diastereomers or mixtures thereof.

An alternative expression for C₁-alkyl is methyl (═CH₃). Accordingly, R¹ at formula I is H or methyl.

The compound of formula I with R¹═H, i.e. compound (103) as depicted in the experimental part at stabilizer 3, is known from example S-7 of WO 2015/121445 A. The compound of formula I with R¹═C₁-alkyl, i.e. compound (104) as depicted in the experimental part at stabilizer 4, is known from example S-8 of WO 2015/121445 A.

Preferred is a composition, wherein R¹ is C₁-alkyl at formula I. With the alternative expression for C₁-alkyl, i.e. methyl: preferred is a composition, wherein R¹ is methyl at formula I.

The polyurethane and the polyether polyol are both susceptible to oxidative, thermal or light-induced degradation. The compound of formula I is incorporated into the polyurethane foam or the polyether polyol for stabilization of the polyurethane foam or the polyether polyol.

A polyurethane is obtained from the reaction of a polyisocyanate reactant and a polyol reactant in a reaction mixture. For generation of the polyurethane foam, a gas generation takes place during the reaction. The gas generation during the reaction can be caused by an addition of water or a carboxylic acid to the reaction mixture prior to the reaction for a chemical gas generation or by an addition of a blowing agent to the reaction mixture prior to the reaction.

In case of addition of water, a water molecule reacts with an isocyanate group, carbon dioxide eliminates and the formed primary amine reacts with a further isocyanate group to form a urea group:

R^{a}—N═C═O+H₂O+R^{b}—N═C═O->R^{a}—NH—C(═O)—NH—R^{b}+CO₂

In case of addition of a carboxylic acid, the carboxylic acid reacts with an isocyanate group, carbon dioxide eliminates and an amide group is formed:

R^{a}—N═C═O+HO(O═)C—R^{c}->R^{a}—NH—C(═O)—R^{c}+CO₂

A blowing agent as used herein means an organic compound, which has a boiling point at 101.32 kPa of between −15° C. and at or below the maximum temperature generated during the reaction of the reaction mixture, preferably between −15° C. and 110° C., more preferably between −10° C. and 80° C. and very preferably between −5° C. and 70° C. Furthermore, the blowing agent does not react under formation of a chemical bond with the polyisocyanate reactant or the polyol reactant in the reaction mixture under the conditions of the reaction. Examples for a blowing agent are alkanes having from 4 to 10 carbon atoms, preferably 5 to 8 carbon atoms, cycloalkanes having from 5 to 10 carbon atoms, acetone, methyl formate, carbon dioxide (added in liquid form) or partially or fully halogenated alkanes having from 1 to 5 carbon atoms, preferably 1 to 3 carbon atoms.

Alkanes having from 4 to 10 carbon atoms are for example butane, pentane, hexane, or heptane. Cycloalkanes having from 5 to 10 carbon atoms are for example cyclopentane or cyclohexane. Partially or fully halogenated alkanes are for example methylene chloride 1,1,1-trichlorethane, CFC-11, CFC-113, CFC-114, CFC-123, CFC-123a, CFC-124, CFC-133, CFC-134, CFC-134a, CFC-141b, CFC-142, CFC-151. From the partially or fully halogenated alkanes having from 1 to 5 carbon atoms, the partially halogenated ones, i.e. those having at least one hydrogen atom, are preferred, for example methylene chloride, CFC-123, CFC-141b, CFC-124 or 1,1,1-trichorloethane.

When water is used for the gas generation, water is preferably added to the reaction mixture prior to the reaction in an amount from 0.5 to 12 parts by weight based on 100 parts by weight of the polyol reactant. More preferably, 1 to 8 parts of water are added. Most preferably, 2 to 7 parts of water are added, for example 3 to 7 or 4 to 7 parts of water. Particularly for a polyurethane foam having a density between 16 and 32 kg/m³, 3 to 8 parts water are added. For a polyurethane foam having a density above 32 kg/m³ and below 48 kg/m³, 2 to 5 parts of water are added.

When a blowing agent is used for the gas generation, the blowing agent is preferably added to the reaction mixture in an amount from 2 to 50 parts by weight based on 100 parts by weight of the polyol reactant. More preferably, 3 to 45 parts of the blowing agent are added. Very preferably, 4 to 30 parts of the blowing agent are added, for example 5 to 25 parts of the blowing agent.

The use of water or a carboxylic acid or the use of a blowing agent provide the desired reduction in density of the polyurethane. When water or a carboxylic acid, particularly water, is used, the reaction exotherm is increased. With the use of water, the amount of urea linkages in the polyurethane foam is increased, which hardens the foam. In contrast, the use of a blowing agent moderates the temperature inside the reaction mixture and softens the foam. Nevertheless, the use of water is attractive but raises the requirements for stabilization of the polyurethane foam, which is generated during the reaction.

A polyurethane foam is for example a normal polyurethane foam or a self-skinning polyurethane foam (structural foam). A normal polyurethane foam possesses the same chemical composition and the same density over a cross section of a structure made out of the normal polyurethane foam. This does of course not apply if such a small scale is chosen that number of void spaces in the cells and the number of the walls of the cells get too small. A self-skinning polyurethane foam (structural foam) possesses the same chemical composition, but the density over a cross section of a structure made out of the self-skinning foam increases from the porous core of the structure towards the outer peripheral zones of the structure. The outer peripheral zones are nearly compact. A normal polyurethane foam is obtained for example by reaction of the reaction mixture in an infinite reaction bin, i.e. the reaction bin is open in a least one direction in the meaning that the emerging foam would not spread significantly further even if the volume of the reaction bin is significantly enlarged. A self-skinning polyurethane foam is for example obtained by reaction of the reaction mixture in a finite reaction bin, i.e. the emerging foam fills the whole volume of the finite reaction bin and the emerging foam would spread significantly further if the volume of the finite reaction bin is enlarged. Furthermore, a temperature gradient exists during the reaction, e.g. by cold surfaces of the finite reaction bin and the uncooled core. By using a blowing agent for the self-skinning polyurethane foam, the formation of a substantially non-cellular skin on the surfaces at the outer peripheral zones of the structure.

The addition of water or a carboxylic acid to the reaction mixture prior to the reaction is preferred, more preferred is the addition of water to the reaction mixture prior to the reaction. Very preferred is the addition of water or a carboxylic acid to the reaction mixture prior to the reaction in case of a normal polyurethane foam. Most preferred is the addition of water to the reaction mixture prior to the reaction in case of a normal polyurethane foam.

The polyurethane foam has a reduced density versus a polyurethane, which is obtained from the same reaction mixture except for a content of water or a carboxylic acid or a content of a blowing agent. The polyurethane foam has preferably a density between 5 to 500 kg/m³ at 20° C. and 101.3 kPa, more preferably between 10 to 300 kg/m³, very preferably 15 to 100 kg/m³ and most preferably 16 to 48 kg/m³. In case the polyurethane foam is a self-skinning foam (structural foam), the density is determined as the average density of the whole foam structure. Often, the density of a self-skinning polyurethane foam is 10 times higher than the density of a normal polyurethane foam.

Preferred is a composition, wherein the polyurethane foam has a density between 5 to 500 kg/m³ at 20° C. and 101.3 kPa.

The polyurethane foam is preferably thermoset.

The polyurethane foam is preferably a semi-rigid cellular material or a flexible (or soft) cellular plastics. More preferably, the polyurethane foam is a flexible (or soft) cellular plastics. A deformation resistance of the polyurethane foam is for example measured according to the norm DIN 53421, wherein a compression stress at 10% compression of 15 kPa or less indicates a flexible cellular plastics. The polyurethane foam is very preferably a flexible (or soft) cellular plastics, which possesses a compression stress at 10% compression of 15 kPa or less according to DIN 53421.

The polyurethane foam is preferably thermoset and a flexible cellular plastics.

A surfactant is preferably added to the reaction mixture prior to the reaction. The surfactant supports the generation of a stable foam from the reaction mixture during the reaction, i.e. a foam which does not collapse until the reaction has progressed to a sufficiently cured stage to maintain is cellular configuration or a foam which does not contain significant quantities of large pores. A surfactant is for example a siloxane derivative, for example a siloxane/poly(alkylene oxide), or a fatty acid salt. Preferably, the surfactant is a siloxane derivative. Since an excess of surfactant tends to cause the reaction mixture to collapse before gelling, the surfactant is preferably added in an amount of 0.05 to 5 parts of weight based on 100 parts of the polyol reactant, more preferably 0.15 to 4 parts, very preferably 0.3 to 3 parts and most preferably 0.8 to 2 parts.

A catalyst for the reaction of a polyisocyanate reactant and a polyol reactant is preferably added to the reaction mixture. The catalyst is for example an amine catalyst or an organometallic catalyst. An amine catalyst is for example triethylenediamine or a derivative based on it, N-methyl morpholine, N-ethyl morpholine, diethyl ethanolamine, N-coco morpholine, 1-methyl-4-dimethylaminoethyl piperazine, 3-methoxy-N-dimethylpropylamine, N,N-diethyl-3-diethylaminopropylamine, dimethylbenzyl amine, bis-(2-dimethylaminoethyl)ether or dimethylbenzyl amine. Preferred is a triethylenediamine or a derivative based on it. An organometallic catalyst is for example an organic salt of tin, bismuth, iron, mercury, zinc or lead. Preferred is an organotin compound. Examples for an organotin compound are dimethyl tin dilaurate, dibutyl tin dilaurate or stannous octoate. Preferred is stannous octoate. Preferably, the amount of an amine catalyst is from 0.01 to 5 parts by weight based on 100 parts by weight of the polyol reactant, more preferably is an amount of 0.03 to 2 parts by weight. Preferably, the amount of an organometallic catalyst is from 0.001 to 3 parts by weight based on 100 parts by weight of the polyol reactant. Preferably, an amine catalyst and an organometallic catalyst are added to the reaction mixture.

The polyisocyanate reactant is an aromatic polyisocyanate or an aliphatic polyisocyanate. An aromatic polyisocyanate is for example 2,4- and/or 2,6-toluene diisocyanate (TDI), 2,4′-diphenylmethanediisocyanate, 1,3- and 1,4-phenylene diisocyanate, 4,4′-diphenylmethane diisocyanate (MDI), 2,4′-diphenylmethane diisocyanate (often contained as a minor isomer in 4,4′-diphenylmethane diisocyanate), 1,5-naphthylene diisocyanate, triphenylmethane-4,4′,4″triisocyanate or polyphenyl-polymethylene polyisocyanates, for example polyisocyanates as prepared by aniline-formaldehyde condensation followed by phosgenization (“crude MDI”). Mixtures of aromatic polyisocyanates are also included. An aliphatic polyisocyanate is for example ethylene diisocyanate, 1,4-tetramethylene diisocyanate, 1,6-hexamethylene diisocyanate, 1,12-dodecane diisocyanate, cyclobutene-1,3-diisocyanate, cyclohexane-1,3- and 1,4-diisocyanate, 1,5-diisocyanate-3,3,5-trimethylcyclohexane, 2,4- and/or 2,6-hexahydrotoluene diisocyanate, perhydro-2,4′- and/or 4,4′-diphenylmethanediisocyanate (H₂MDI) or isophorone diisocyanate. Mixtures of aliphatic polyisocyanates are also included. In addition, derivatives and prepolymers of the foregoing aromatic polyisocyanate or aliphatic polyisocyanate are included, for example these containing urethane, carbodiimide, allophanate, isocyanurate, acylated urea, biuret or ester groups (“modified polyisocyanates”). For an aromatic polyisocyanurate, the so-called “liquid MDI” products which contain carbodiimide groups are an example. It is also possible to employ the isocyanate group-containing distillation residues of aromatic polyisocyanates or aliphatic polyisocyanates, as it is or dissolved in one or more of the abovementioned polyisocyanates, which are obtained in the course of the industrial preparation of isocyanates. Preferred polyisocyanate reactants are the aromatic polyisocyanates TDI, MDI or derivatives of MDI, and the aliphatic polyisocyanates isophorone diisocyanate, H₁₂MDI, hexamethylene diisocyanate or cyclohexane diisocyanate. Very preferred are aromatic polyisocyanates. Most preferred is a polyisocyanate, which is TDI, MDI or a derivative of MDI. Especially preferred is a polyisocyanate, which is TDI, particularly a mixture of 2,4-toluene diisocyanate and 2,6-toluene diisocyanate.

The polyisocyanate reactant is preferably used in an amount to provide an isocyanate index of 90 to 130, more preferably 95 to 115, most preferably 100 to 113 and especially preferably 105 to 112. The isocyanate index is used herein to mean 100 times the ratio of the used isocyanate groups relative to the theoretical equivalent amount needed to react with the active hydrogen equivalents in the reaction mixture, e.g. in the polyol reactant and—if present—in water, carboxylic acid, crosslinker, chain extender and in other components with a functional group, which is an active hydrogen-containing group and thus is reactive towards an isocyanate group. An index 100 indicates a stoichiometry 1 to 1 and an index 107 indicates for example a 7% excess of isocyanate equivalents. Isocyanate equivalents are the overall number of isocyanate groups. Active hydrogen equivalents means the overall number of active hydrogens. An active hydrogen-containing group, which is a hydroxyl group or a secondary amine group, contributes one active hydrogen equivalent. An active hydrogen-containing group, which is a primary amine group, contributes also one active hydrogen equivalent. This is because after reaction with one isocyanate group, the second original hydrogen is no longer an active hydrogen. An active hydrogen-containing group, which is a carboxylic acid, contributes one active hydrogen equivalent for one carboxylic acid functionality.

The polyol reactant is a polyether polyol or a polyester polyol.

The polyether polyol is for example a polymer obtainable by polymerization of alkylene oxides or cyclic ethers with at least 4 ring atoms, which contains at least two active hydrogen-containing groups per molecule and at least two the contained active hydrogen-containing groups per molecule are hydroxyl groups. An active hydrogen-containing group is for example a primary hydroxyl group, a secondary hydroxyl group, a primary amine or a secondary amine. The intended function of the active hydrogen-containing group is the reaction with an isocyanate to form a covalent bond therewith. Preferably, the polyether polyol contains 2 to 8 active hydrogen-containing groups per molecule, very preferably 2 to 6, and most preferably 2 to 4 and especially preferably 2 to 3. A number of three active hydrogen-containing groups per molecule in the polyether polyol is also called a trifunctional polyether polyol. Alkylene oxides are for example ethylene oxide, propylene oxide, 1,2-butylene oxide, 2,3-butylene oxide or styrene oxide. Cyclic ethers are for example oxetane or tetrahydrofuran.

The polyether polyol is prepared for example by polymerizing alkylene oxides, alone or as a mixture or in succession, with initiator components containing at least two reactive hydrogen atoms. An initiator component containing at least two reactive hydrogen atoms is for example water, a polyalcohol, ammonia, a primary amine or a secondary amine containing a second reactive hydrogen atom. A polyalcohol is for example ethylene glycol, propane-1,2-diol, propane-1,3-diol, glycerine, trimethylolpropane, 4,4′-dihydroxydiphenylpropane or alphamethylglucoside. A primary amine is for example ethanolamine, ethylene diamine, diethylenetriamine or aniline. A secondary amine containing a second reactive hydrogen atom is for example diethanolamine, triethanolamine or N-(2-hydroxyethyl)piperazine. The initiator component containing at least two reactive hydrogen atoms is preferably water or a polyalcohol. The initiator component containing at least two reactive hydrogen atoms contains preferably 2 to 6 reactive hydrogen atoms, more preferably 2 to 4 and most preferably 2 to 3. The average number of reactive hydrogen atoms in the initiator component used in preparing the polyether polyol defines a “nominal functionality” of the polyether polyol, i.e. the average number of active hydrogen-containing groups of the polyether polyol. The nominal functionality of the polyether polyol is preferably from 2 to 6, more preferably from 2 to 4, most preferably from 2 to 3.5 and especially preferably from 2 to 3.3.

The polyether polyol has for example a molecular weight of 400 to 10000 Dalton, preferably 800 to 10000 Dalton. The molecular weight is more preferably determined as the number average molecular weight (Mₙ or number average molar mass). Equivalent weight of the polyether polyol is defined herein as the molecular weight of the polyether polyol divided by its average number of active hydrogen-containing groups per molecule, preferably the number average molecular weight (Mₙ) is taken for determination of the equivalent weight. The equivalent weight of the polyether polyol, especially determined with the number average molecular weight (Mₙ), is preferably 400 to 5000, more preferably 800 to 2500, very preferably 900 to 1300 and especially preferably 1000 to 1200.

Preferred is a polyether polyol, which contains pre-dominantly (up to 90% by weight, based on all the hydroxyl groups present in the polyether polyol) active hydrogen-containing groups, which are secondary hydroxyl groups.

A polyester polyol is produced for example by polycondensation of a diacid and a diol, wherein the diol is applied in excess. Partial replacement of the diol by a polyol with more than two hydroxyl groups leads to a ramified polyester polyol. A diacid is for example adipic acid, glutaric acid, succinic acid, maleic acid or phthalic acid. A diol is for example ethylene glycol, diethylene glycol, 1,4-butane diol, 1,5-pentane diol, neopentyl glycol or 1,6-hexane diol. A polyol with more than two hydroxyl groups is for example glycerine, trimethylol propane or pentaerythritol.

A crosslinker is for example a further component of the reaction mixture. A crosslinker can improve the resiliency of the polyurethane foam. A crosslinker as defined herein possesses three 3 to 8, preferably 3 to 4 active hydrogen-containing groups per molecule. The crosslinker thus reacts with the polyisocyanate reactant and if present is considered as a reactant for calculation of the polyisocyanate index. The crosslinker is free of an ester bond and possesses an equivalent weight, especially determined with the number average molecular weight (Mᵣ), of below 200. In case of the presence of a crosslinker, the polyether polyol possesses preferably an equivalent weight of the polyether polyol, especially determined with the number average molecular weight (Mₙ), of 400 to 5000. A crosslinker is for example an alkylene triol or an alkanolamine. An alkylene triol is for example glycerine or trimethylolpropane. An alkanolamine is for example diethanolamine, triisopropanolamine, triethanolamine, diisopropanolamine, an adduct of 4 to 8 moles of ethylene oxide with ethylene diamine or an adduct of 4 to 8 moles of propylene oxide with ethylene diamine. The crosslinker is preferably an alkanolamine, more preferably diethanolamine.

A chain extender is for example a further component of the reaction mixture. A chain extender as defined herein possesses two active hydrogen-containing groups per molecule, which are hydroxyl groups. The chain extender thus reacts with the polyisocyanate reactant and if present is considered as a reactant for calculation of the polyisocyanate index. The chain extender is free of an ester bond and possesses an equivalent weight, especially determined with the number average molecular weight (Mᵣ), of between 31 and 300, preferably 31 to 150. In case of the presence of a chain extender, the polyether polyol possesses preferably an equivalent weight, especially determined with the number average molecular weight (Mₙ), of 400 to 5000. A chain extender is for example an alkylene glycol or a glycol ether. An alkylene glycol is for example ethylene glycol, 1,3-propylene glycol, 1,4-butylene glycol or 1,6-hexamethylene glycol. A glycol ether is for example diethylene glycol, triethylene glycol, dipropylene glycol, tripropylene glycol or 1,4-cyclohexanedimethanol.

If used, the combined amount of crosslinker and the chain extender in the reaction mixture is below 50 parts by weight based on 100 parts by weight of the polyol reactant. The combined amount is preferably below 20 parts by weight, more preferably below 5 parts by weight.

The reaction mixture prior to the reaction comprises a polyisocyanate reactant and a polyol reactant, and 60 to 100 parts by weight of the polyol reactant based on 100 parts by weight of the polyol reactant is preferably a polyether polyol. More preferably, 80 to 100 parts by weight of the polyol reactant is a polyether polyol, very preferably 95 to 100 parts by weight, most preferably 98 to 100 parts by weight and especially preferably, the polyol reactant is a polyether polyol.

The polyurethane foam is obtained from the reaction of the reaction mixture. The aforementioned preference can be expressed in an alternative form, i.e. the polyurethane foam is preferably obtained from the reaction of a polyisocyanate reactant and a polyol in a reaction mixture, and 60 to 100 parts by weight of the polyol reactant based on 100 parts by weight of the polyol reactant is a polyether polyol.

Preferred is a composition, wherein the polyurethane foam is obtained from the reaction of a polyisocyanate reactant and a polyol reactant in a reaction mixture.

Preferred is a composition, wherein the polyurethane foam is obtained from the reaction of a polyisocyanate reactant and a polyol reactant in a reaction mixture, wherein the reaction mixture comprises the polyisocyanate reactant, the polyol reactant and optionally water, a carboxylic acid or a blowing agent and optionally a surfactant and optionally a catalyst and optionally a crosslinker and optionally a chain extender.

Preferred is a composition, wherein the polyurethane foam is obtained from the reaction of a polyisocyanate reactant and a polyol reactant in a reaction mixture, and 60 to 100 parts by weight of the polyol reactant based on 100 parts by weight of the polyol reactant is a polyether polyol.

Preferred is a composition, wherein the polyurethane foam is obtained from the reaction of a polyisocyanate reactant and a polyol reactant in a reaction mixture, and the reaction mixture contains prior to the reaction water, a carboxylic acid or a blowing agent.

Preferred is a composition, wherein component (a) is a polyurethane foam.

Preferred is a composition, wherein component (a) is a polyether polyol.

The content of component (b), i.e. a compound of formula I, in the composition is defined for a polyurethane foam as component (a) based on the polyol reactant in the reaction mixture, which reacts with the polyisocyanate reactant afterwards to form the polyurethane foam. The content of component (b), i.e. a compound of formula I, in the composition is defined for a polyether polyol as component (a) based on the polyether polyol. For both cases, the amount of component (b) is preferably from 0.01 to 2 parts by weight based on 100 parts by weight of the polyol reactant in case of a polyurethane foam or of the polyether polyol in case of a polyether polyol. More preferably, the amount is from 0.02 to 1.5 parts by weight, very preferably from 0.025 to 1.2 parts by weight and most preferably from 0.03 to 1.1 parts by weight.

Preferred is a composition, wherein the polyurethane foam is obtained from the reaction of a polyisocyanate reactant and a polyol reactant in a reaction mixture, and the amount of component (b) is in case of the polyurethane foam from 0.01 to 2 parts by weight based on 100 parts by weight of the polyol reactant and in case of a polyether polyol from 0.01 to 2 parts by weight based on 100 parts by weight of the polyether polyol.

The composition comprising component (a) and component (b) contains for example a first further additive as component (c). The first further additive is for example selected from the from the following list:

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, 2,4-dimethyl-6-(1′-methyl-1′-tetradecyl-methyl)-phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, 6-tocopherol and mixtures thereof (vitamin E), vitamin E acetate.

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tertbutylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tertbutylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tertbutyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid, (3,5-ditertbutyl-4-hydroxy-phenyl)methylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, for example with methanol, ethanol, n-octanol, i-octanol, a mixture of linear and branched C₇-C₉-alkanol, octadecanol, a mixture of linear and branched C₁₃-C₁₅-alkanol, 1,6-hexanediol, 1,9-nonanediol, ethylene glycol, 1,2-propanediol, neopentyl glycol, thiodiethylene glycol, diethylene glycol, triethylene glycol, tetraethylene glycol, pentaerythritol, tris(hydroxyethyl)isocyanurate, N,N′-bis-(hydroxy-ethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.

1.15. Esters of β-(3,5-dicyclohexyl-4-hydroxyphenyl)propionic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid, for example N,N′-bis(3,5-ditert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard XL-1 (RTM), supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-pphenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines or a mixture of mono- and dialkylated tert-octylphenothiazines, N-allylphenothiazine, N,N,N′,N′-tetraphenyl-1,4-diaminobut-2-ene.

2. UV absorbers and light stabilisers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tertbutyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

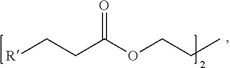

where R′=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate, N-(β-carbomethoxy-β-cyanovinyl)-2-methylindoline and neopentyl tetra(α-cyano-β,β-diphenylacrylate).

2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-ditert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperid-4-yl)sebacate, bis(1-octyloxy-2,2,6,6-tetramethylpiperid-4-yl)succinate, bis-[2,2,6,6-tetramethyl-1-(undecyloxy)-piperidin-4-yl] carbonate, linear or cyclic condensates of N,N′-bis(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropyl-amino)ethane, 8-acetyl-3-dodecyl-7,7,9,9-tetramethyl-1,3,8-triazaspiro[4.5]-decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268 64-7]); reaction products of N6,N6′-hexane-1,6-diylbis[N2,N4-dibutyl-N2,N4,N6-tris(2,2,6,6-tetramethylpiperidin-4-yl)-1,3,5-triazine-2,4,6-triamine], butanal and hydrogen peroxide; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)-ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxy-piperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, a mixture of oligomeric compounds which are the formal condensation products of N,N′-bis-(2,2,6,6-tetramethyl-1-propoxy-piperidin-4-yl)-hexane-1,6-diamine and 2,4-dichloro-6-{n-butyl-(2,2,6,6-tetramethyl-1-propoxy-piperidin-4-yl)-amino}-[1,3,5]triazine end-capped with 2-chloro-4,6-bis-(di-n-butylamino)-[1,3,5]triazine, a mixture of oligomeric compounds which are the formal condensation products of N,N′-bis-(2,2,6,6-tetramethyl-piperidin-4-yl)-hexane-1,6-diamine and 2,4-dichloro-6-{n-butyl-(2,2,6,6-tetramethyl-piperidin-4-yl)-amino}-[1,3,5]triazine end-capped with 2-chloro-4,6-bis-(di-n-butylamino)-[1,3,5]triazine, (N2,N4-dibutyl-N2,N4-bis(1,2,2,6,6-pentamethyl-4-piperidinyl)-6-(1-pyrrolidinyl)-[1,3,5]-triazine-2,4-diamine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. [106917-31-1]), 5-(2-ethylhexanoyl)-oxymethyl-3,3,5-trimethyl-2-morpholinone, the reaction product of 2,4-bis-[(1-cyclo-hexyloxy-2,2,6,6-piperidine-4-yl)butylamino]-6-chloro-s-triazine with N,N′-bis-(3-amino-propyl)ethylenediamine), 1,3,5-tris(N-cyclohexyl-N-(2,2,6,6-tetramethyl-piperazine-3-one-4-yl)amino)-s-triazine, 1,3,5-tris(N-cyclohexyl-N-(1,2,2,6,6-pentamethylpiperazine-3-one-4-yl)amino)-s-triazine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, which are different to a compound of formula I, for example triphenyl phosphite, diphenylalkyl phosphites, phenyldialkyl phosphites, tris(nonylphenyl) phosphite, C₁₂-C₁₈ alkyl bis[4-(1-methyl-1-phenyl-ethyl)phenyl] phosphite, C₁₂-C₁₈ alkenyl bis[4-(1-methyl-1-phenyl-ethyl)phenyl] phosphite, bis[4-(1-methyl-1-phenyl-ethyl)phenyl] [(E)-octadec-9-enyl] phosphite, decyl bis[4-(1-methyl-1-phenyl-ethyl)phenyl] phosphite, didecyl [4-(1-methyl-1-phenyl-ethyl)phenyl] phosphite, [4-(1-methyl-1-phenyl-ethyl)phenyl] bis[(E)-octadec-9-enyl]phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, [2-tert-butyl-4-[1-[5-tert-butyl-4-di(tridecoxy)phosphanyloxy-2-methyl-phenyl]butyl]-5-methyl-phenyl] ditridecyl phosphite, tristearyl sorbitol triphosphite, a mixture of at least two different tris(mono-C₁-C₈-alkyl)phenyl phosphites such as for example mentioned in U.S. Pat. No. 7,468,410 B2 as products of examples 1 and 2, a mixture of phosphites comprising at least two different tris(amylphenyl) phosphites such as for example mentioned in U.S. Pat. No. 8,008,383 B2 as mixtures 14, 15, 16, 17, 18, 19, 20, 21, 22, 23, 24, 25 and 26, a mixture of a least four different phosphites comprising tris[4-(1,1-dimethylpropyl)phenyl] phosphite, [2,4-bis(1,1-dimethylpropyl)phenyl] bis[4-(1,1-dimethylpropyl)phenyl] phosphite, bis[2,4-bis(1,1-dimethylpropyl)phenyl] [4-(1,1-dimethylpropyl)phenyl] phosphite and tris[2,4-bis(1,1-dimethylpropyl)phenyl] phosphite, a mixture of phosphites comprising at least two different tris(butylphenyl) phosphites such as for example mentioned in U.S. Pat. No. 8,008,383 B2 as mixtures 34, 35, 36, 37, 38, 39 and 40, an oxyalkylene-bridged bis-(di-C₆-aryl) diphosphite or an oligomeric phosphite obtainable by condensation under removal of hydrogen chloride of (i) a trichlorophosphane, with (ii) a dihydroxyalkane interrupted by one or more oxygen atoms and with (iii) a mono-hydroxy-C₆-arene such as for example mentioned in U.S. Pat. No. 8,304,477 B2 as products of examples 1, 2, 3, 4, 5, 6, 7, 8, 9, 10, 11, 12, 13, 14, 15, 16 and 17, a polymeric phosphite obtainable by transesterification under removal of phenol of (i) triphenyl phosphite with (ii) a dihydroxyalkane optionally interrupted by one or more oxygen atoms and/or a bis(hydroxyalkyl)(alkyl)amine and with (iii) a mono-hydroxyalkane optionally interrupted by one or more oxygen atoms such as for example mentioned in U.S. Pat. No. 8,563,637 B2 as products of examples 1, 2, 3, 4, 5, 6, 7, 8, 9, 10 and 11, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocine, 1,3,7,9-tetra-tert-butyl-11-octoxy-5H-benzo[d][1,3,2]benzodioxaphosphocine, 2,2′,2″-nitrilo[triethyltris(3,3′,5,5′-tetra-tert-butyl-1,1′-biphenyl-2,2′-diyl)phosphite], phosphorous acid, triphenyl ester, polymer with α-hydro-w-hydroxypoly[oxy(methyl-1,2-ethanediyl)], C10-16-alkyl esters (CAS Reg. No. [1227937-46-3]), 2-ethylhexyl(3,3′,5,5′-tetra-tert-butyl-1,1′-biphenyl-2,2′-diyl)phosphite, 5-butyl-5-ethyl-2-(2,4,6-tritert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS Reg. No. [939402-02-5]).

The following phosphites are especially preferred:

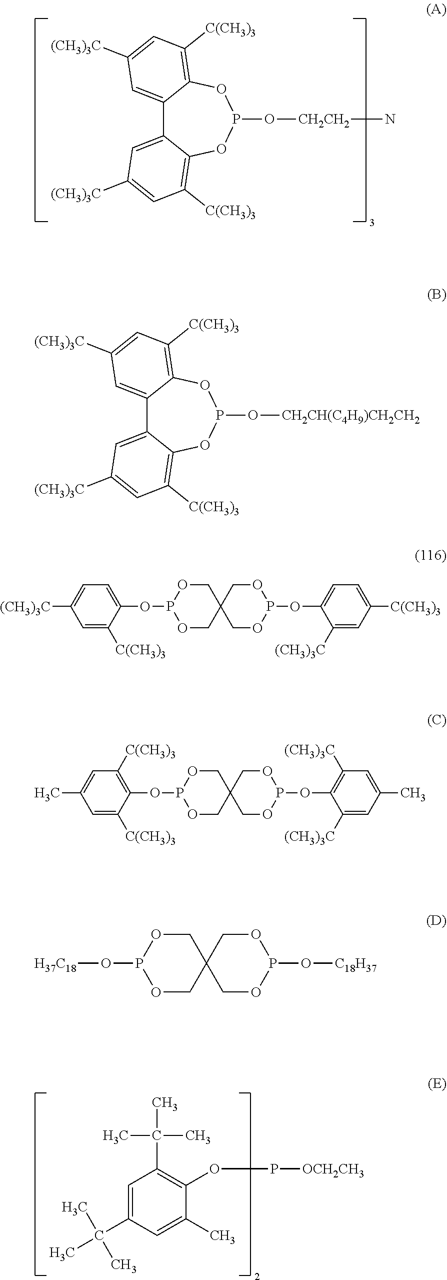

5. Hydroxylamines and amine N-oxides, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine, N,N-bis-(hydrogenated rape-oil alkyl)-N-methyl-amine N-oxide or trialkylamine N-oxide.

6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-octadecyl-alpha-pentadecylnitrone, N-heptadecyl-alpha-heptadecylnitrone, Noctadecyl-alpha-hexadecylnitrone, nitrone derived from N,N-dialkylhydroxylamine derived from hydrogenated tallow amine.

7. Thiosynergists, for example dilauryl thiodipropionate, dimistryl thiodipropionate, distearyl thiodipropionate and pentaerythritol tetrakis-[3-(n-lauryl)-propionic acid ester].

8. Peroxide scavengers, for example esters of α-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Acid scavengers, for example melamine, polyvinylpyrrolidone, dicyandiamide, triallyl cyanurate, urea derivatives, hydrazine derivatives, alkali metal salts and alkaline earth metal salts of higher fatty acids, for example calcium stearate, zinc stearate, magnesium behenate, magnesium stearate, sodium ricinoleate and potassium palmitate, antimony pyrocatecholate and zinc pyrocatecholate.

10. Benzofuranones, which are different to a compound of formula I, and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839 or EP-A-0591102, or 5,7-di-tert-butyl-3-(4-hydroxyphenyl)-3H-benzofuran-2-one, 5,7-di-tert-butyl-3-[4-(2-hydroxyethoxy)phenyl]-3H-benzofuran-2-one, 5,7-di-tert-butyl-3-[4-[2-[2-[2-[2-(2-hydroxyethoxy)ethoxy]ethoxy]ethoxy]ethoxy]phenyl]-3H-benzofuran-2-one, 3-[4-(2-acetoxyethoxy)phenyl]-5,7-ditert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetoxy-4-(1,1,3,3-tetramethyl-butyl)-phenyl)-5-(1,1,3,3-tetramethyl-butyl)-benzofuran-2-one, [6-[6-[6-[2-[4-(5,7-di-tert-butyl-2-oxo-3H-benzofuran-3-yl)phenoxy]ethoxy]-6-oxohexoxy]-6-oxo-hexoxy]-6-oxo-hexyl] 6-hydroxyhexanoate, [4-tert-butyl-2-(5-tert-butyl-2-oxo-3H-benzofuran-3-yl)phenyl] benzoate, [4-tert-butyl-2-(5-tert-butyl-2-oxo-3H-benzofuran-3-yl)phenyl]3,5-di-tert-butyl-4-hydroxy-benzoate and [4-tert-butyl-2-(5-tert-butyl-2-oxo-3H-benzofuran-3-yl)phenyl] 3-(3,5-di-tert-butyl-4-hydroxy-phenyl)propanoate.

11. Flame retardants

11.1. Phosphorus containing flame retardants including reactive phosphorous containing flame retardants, for example tetraphenyl resorcinol diphosphite (Fyrolflex RDP, RTM, Akzo Nobel), tetrakis(hydroxymethyl)phosphonium sulphide, triphenyl phosphate, diethyl-N,N-bis(2-hydroxyethyl)-aminomethyl phosphonate, hydroxyalkyl esters of phosphorus acids, alkylphosphate oligomers, ammonium polyphosphate (APP), resorcinol diphosphate oligomer (RDP), phosphazene flame retardants or ethylenediamine diphosphate (EDAP).

11.2. Nitrogen containing flame retardants, for example melamine-based flame retardants, isocyanurates, polyisocyanurate, esters of isocyanuric acid, like tris-(2-hydroxyethyl)isocyanurate, tris(hydroxymethyl)isocyanurate, tris(3-hydroxy-n-propyl)isocyanurate, triglycidyl isocyanurate, melamine cyanurate, melamine borate, melamine phosphate, melamine pyrophosphate, melamine polyphosphate, melamine ammonium polyphosphate, melamine ammonium pyrophosphate, dimelamine phosphate, dimelamine pyrophosphate, benzoguanamine, allantoin, glycoluril, urea cyanurate, a condensation product of melamine from the series melem, melam, melon and/or a higher condensed compound or a reaction product of melamine with phosphoric acid or a mixture thereof.

11.3. Organohalogen flame retardants, for example polybrominated diphenyl oxide (DE-60F, Great Lakes), decabromodiphenyl oxide (DBDPO; Saytex 102E (RTM, Albemarle)), tris[3-bromo-2,2-bis(bromomethyl)propyl] phosphate (PB 370, (RTM, FMC Corp.)), tris(2,3-dibromopropyl)phosphate, chloroalkyl phosphate esters such as tris(chloropropyl)phosphate, tris(2,3-dichloropropyl)phosphate, tris(1,3-dichloro-2-propyl)phosphate (Fyrol FR 2 (RTM ICL)), oligomeric chloroalkyl phosphate, chlorendic acid, tetrachlorophthalic acid, tetrabromophthalic acid, poly-β-chloroethyl triphosphonate mixture, tetrabromobisphenol A-bis(2,3-dibromopropyl ether) (PE68), brominated epoxy resin, brominated aryl esters, ethylene-bis(tetrabromophthalimide) (Saytex BT-93 (RTM, Albemarle)), bis(hexachlorocyclopentadieno) cyclooctane (Declorane Plus (RTM, Oxychem)), chlorinated paraffins, octabromodiphenyl ether, hexachlorocyclopentadiene derivatives, 1,2-bis(tribromophenoxy)ethane (FF680), tetrabromobisphenol A (Saytex RB100 (RTM, Albemarle)), ethylene bis-(dibromonorbornanedicarboximide) (Saytex BN-451 (RTM, Albemarle)), bis-(hexachlorocycloentadeno)cyclooctane, PTFE, tris (2,3-dibromopropyl) isocyanurate or ethylene-bis-tetrabromophthalimide.

Some of the halogenated flame retardants mentioned above are routinely combined with an inorganic oxide synergist. Some of the halogentated flame retardants mentioned above can be used in combination with triaryl phosphates (such as the propylated, butylated triphenyl phosphates) and the like and/or with oligomeric aryl phosphates (such as resorcinol bis(diphenyl phosphate), bisphenol A bis(diphenyl phosphate), neopentylglycol bis(diphenyl phosphate)) and the like.

11.4. Inorganic flame retardants, for example aluminium trihydroxide (ATH), boehmite (AlOOH), magnesium dihydroxide (MDH), zinc borates, CaCO₃, organically modified layered silicates, organically modified layered double hydroxides, and mixtures thereof. In regard to the synergistic combination with halogenated flame retardants, the most common inorganic oxide synergists are zinc oxides, antimony oxides like Sb₂O₃ or Sb₂O₅ or boron compounds.

The first further additive is preferably an aromatic amine, a phosphite different to a compound of formula I or a phenolic additive. More preferably, the first further additive is a phenylarylamine with one nitrogen atom, wherein the nitrogen atom is only substituted with a phenyl and an C₆-C₁₀-aryl and the phenyl or the C₆-C₁₀-aryl is alkylated, a phosphite, which is an ester of at least one aliphatic alcohol having at least one primary hydroxyl group, or a phenolic antioxidant, which is an ester of 3-(3,5-ditert-butyl-4-hydroxy-phenyl)propanoic acid or an ester of 3-(3-tertbutyl-4-hydroxy-5-methyl-phenyl)propanoic acid.

A phenylarylamine with one nitrogen atom, wherein the nitrogen atom is only substituted with a phenyl and an C₆-C₁₀-aryl and the phenyl or the C₆-C₁₀-aryl is alkylated, is for example N-phenyl-1-naphthylamine, N-(4-tert-octylphenyl)-1-naphthylamine, octylated diphenylamine, for example p,p′-di-tert-octyldiphenylamine, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines or a mixture of mono- and dialkylated tert-butyldiphenylamines. Preferred is N-[(1,1,3,3-tetramethylbutyl)phenyl]-1-napthalenamine (i.e. compound (115) in the experimental part) or a technical mixture obtained by the reaction of diphenylamine with diisobutylene, comprising
(A)₅₀₅₇ diphenylamine;
(B)₅₀₅₇ 4-tert-butyldiphenylamine;
(C)₅₀₅₇ compounds of the group
   i) 4-tert-octyldiphenylamine,
   ii) 4,4′-di-tert-butyldiphenylamine,
   iii) 2,4,4′-tris-tert-butyldiphenylamine,
(D)₅₀₅₇ compounds of the group
   i) 4-tert-butyl-4′-tert-octyldiphenylamine,
   ii) o,o′, m,m′, or p,p′-di-tert-octyldiphenylamine,
   iii) 2,4-di-tert-butyl-4′-tert-octyldiphenylamine,
(E)₅₀₅₇ compounds of the group
   i) 4,4′-di-tert-octyldiphenylamine,
   ii) 2,4-di-tert-octyl-4′-tert-butyldiphenylamine, and
      wherein not more than 5% by weight of component (A)₅₀₅₇, 8 to 15% by weight of component (B)₅₀₅₇, 24 to 32% by weight of component (C)₅₀₅₇, 23 to 34% by weight of component (D)₅₀₅₇ and 21 to 34% by weight of component (E)₅₀₅₇ are present.

A phosphite, which is an ester of at least one aliphatic alcohol having at least one primary hydroxyl group (i.e. HO—CH₂— . . . ), is for example diphenylethyl phosphite, phenyldiethyl phosphite, decyl bis[4-(1-methyl-1-phenyl-ethyl)phenyl] phosphite, didecyl [4-(1-methyl-1-phenyl-ethyl)phenyl] phosphite, trilauryl phosphite, trioctadecyl phosphite, distearylpentaerythritol diphosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, bis(2,4-di-tert-butyl-6-methylphenyl)pentaerythritol diphosphite, bis(2,4,6-tris(tert-butylphenyl)pentaerythritol diphosphite, [2-tert-butyl-4-[1-[5-tert-butyl-4-di(tridecoxy)phosphanyloxy-2-methyl-phenyl]butyl]-5-methyl-phenyl] ditridecyl phosphite, tristearyl sorbitol triphosphite, an oxyalkylene-bridged bis-(di-C₆-aryl) diphosphite or an oligomeric phosphite obtainable by condensation under removal of hydrogen chloride of (i) a trichlorophosphane, with (ii) a dihydroxyalkane interrupted by one or more oxygen atoms and with (iii) a mono-hydroxy-C₆-arene such as for example mentioned in U.S. Pat. No. 8,304,477 B2 as products of examples 1, 2, 3, 4, 5, 6, 7, 8, 9, 10, 11, 12, 13, 14, 15, 16 and 17, a polymeric phosphite obtainable by transesterification under removal of phenol of (i) triphenyl phosphite with (ii) a dihydroxyalkane optionally interrupted by one or more oxygen atoms and/or a bis(hydroxyalkyl)(alkyl)amine and with (iii) a mono-hydroxyalkane optionally interrupted by one or more oxygen atoms such as for example mentioned in U.S. Pat. No. 8,563,637 B2 as products of examples 1, 2, 3, 4, 5, 6, 7, 8, 9, 10 and 11, 6-isooctyloxy-2,4,8,10-tetra-tert-butyl-12H-dibenz[d,g]-1,3,2-dioxaphosphocine, bis(2,4-di-tert-butyl-6-methylphenyl)methyl phosphite, bis(2,4-di-tert-butyl-6-methylphenyl)ethyl phosphite, 1,3,7,9-tetra-tert-butyl-11-octoxy-5H-benzo[d][1,3,2]benzodioxaphosphocine, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite or 5-butyl-5-ethyl-2-(2,4,6-tri-tert-butylphenoxy)-1,3,2-dioxaphosphirane. Preferred is bis(2,4-di-tert-butylphenyl)pentaerythritol diphosphite (i.e. compound (116) in the experimental part), bis(2,4-di-tert-butyl-6-methylphenyl)ethyl phosphite, bis(2,6-di-tert-butyl-4-methylphenyl)pentaerythritol diphosphite, 6-(2-ethyl-hexyl-1-oxy)-2,4,8,10-tetramethyl-benzo[d][1,3,2]benzodioxaphosphepine or distearylpentaerythritol diphosphite. Very preferred is bis(2,4-di-tert-butylphenyl)pentaerythritol diphosphite or bis(2,4-di-tert-butyl-6-methylphenyl)ethyl phosphite.

A phenolic antioxidant, which is an ester of 3-(3,5-ditert-butyl-4-hydroxy-phenyl)propanoic acid or an ester of 3-(3-tert-butyl-4-hydroxy-5-methyl-phenyl)propanoic acid, is for example 2-[2-[2-[3-(3-tert-butyl-4-hydroxy-5-methyl-phenyl)propanoyloxy]ethoxy]ethoxy]ethyl 3-(3-tert-butyl-4-hydroxy-5-methyl-phenyl)propanoate (i.e. compound (109) as depicted in the experimental part), 3-(3,5-di-tert-butyl-4-hydroxy-phenyl)-propionic acid iso-octyl ester (i.e. compound 112 as depicted in the experimental part), stearyl 3-(3,5-ditert-butyl-4-hydroxy-phenyl)propanoate (i.e. compound (113) as depicted in the experimental part), tetrakis-[3-(3,5-di-tert-butyl-4-hydroxyphenyl)-propionyloxymethyl]methane (i.e. compound (111) as depicted in the experimental part) or 2-[2-[2-[2-[3-(3,5-ditert-butyl-4-hydroxy-phenyl)propanoyloxy]ethoxy]ethoxy]ethoxy]ethyl 3-(3,5-ditert-butyl-4-hydroxy-phenyl)propanoate (i.e. compound (108) as depicted in the experimental part). Preferably, the phenolic antioxidant, which is an ester of 3-(3,5-ditert-butyl-4-hydroxy-phenyl)propanoic acid or an ester of 3-(3-tert-butyl-4-hydroxy-5-methyl-phenyl)propanoic acid, is an ester with an aliphatic alcohol having at least one primary hydroxyl group (i.e. HO—CH₂— . . . ). More preferably, the phenolic antioxidant is an ester of 3-(3,5-ditert-butyl-4-hydroxyphenyl)propanoic acid and an aliphatic alcohol having at least one primary hydroxyl group. Most preferably, the phenolic antioxidant is an ester of 3-(3,5-ditert-butyl-4-hydroxy-phenyl)propanoic acid and an aliphatic alcohol having at least one primary hydroxyl group and being free of secondary or tertiary hydroxyl groups. Very preferably, the phenolic antioxidant is an ester of 3-(3,5-ditert-butyl-4-hydroxy-phenyl)propanoic acid and an aliphatic alcohol having at least one primary hydroxyl group and being free of secondary or tertiary hydroxyl groups and has a melting point below 60° C. at 101.32 kPa. Very preferred is 3-(3,5-di-tert-butyl-4-hydroxy-phenyl)-propionic acid iso-octyl ester, stearyl 3-(3,5-ditert-butyl-4-hydroxy-phenyl)propanoate or 2-[2-[2-[2-[3-(3,5-ditert-butyl-4-hydroxy-phenyl)propanoyloxy]ethoxy]ethoxy]ethoxy]ethyl 3-(3,5-ditert-butyl-4-hydroxy-phenyl)propanoate.

Preferred is a composition, which comprises as component (c) additionally a first further additive.

Preferred is a composition, which comprises as component (c) a first further additive, which is an aromatic amine, a phosphite different to a compound of formula I or a phenolic antioxidant.

Preferred is a composition, which comprises as component (c) a first further additive, which is a phenylarylamine with one nitrogen atom, wherein the nitrogen atom is only substituted with a phenyl and an C₆-C₁₀-aryl and the phenyl or the C₆-C₁₀-aryl is alkylated, a phosphite, which is an ester of at least one aliphatic alcohol having at least one primary hydroxyl group, or a phenolic antioxidant, which is an ester of 3-(3,5-ditert-butyl-4-hydroxy-phenyl)propanoic acid or an ester of 3-(3-tert-butyl-4-hydroxy-5-methyl-phenyl)propanoic acid.

Preferred is a composition, which comprises as component (c) a first further additive, which is a phenylarylamine with one nitrogen atom, wherein the nitrogen atom is only substituted with a phenyl and an C₆-C₁₀-aryl and the phenyl or the C₆-C₁₀-aryl is alkylated.

Preferred is a composition, which comprises as component (c) a first further additive, which is a phosphite, which is an ester of at least one aliphatic alcohol having at least one primary hydroxyl group.

Preferred is a composition, which comprises as component (c) a first further additive, which is a phenolic antioxidant, which is an ester of 3-(3,5-ditert-butyl-4-hydroxy-phenyl)propanoic acid or an ester of 3-(3-tert-butyl-4-hydroxy-5-methyl-phenyl)propanoic acid.

Preferred is a composition, which comprises as component (c) a first further additive, which is a phenolic antioxidant, which is an ester of 3-(3,5-ditert-butyl-4-hydroxy-phenyl)propanoic acid.

The weight ratio between component (b), i.e. a compound of formula I, and component (c), i.e. the first further additive, is preferably from 0.08 to 2. More preferably, the weight ratio is from 0.1 to 1.5, very preferably from 0.2 to 1.2 and most preferably from 0.3 to 0.9.

Preferred is a composition, wherein the weight ratio between component (b) and component (c) is from 0.08 to 2.

The composition comprising component (a) and component (b) contains for example the first further additive as component (c) and a second further as component (d), wherein the second further additive is different to a compound of formula I and to the first further additive. The second further additive is for example selected from the from same list as previously described for the first further additive. Preferably, the first further additive is a phenolic antioxidant and the second further additive is an aromatic amine or a phosphite different to formula I. More preferably, the first further additive is a phenolic antioxidant, which is an ester of 3-(3,5-ditert-butyl-4-hydroxy-phenyl)propanoic acid or an ester of 3-(3-tert-butyl-4-hydroxy-5-methyl-phenyl)propanoic acid, and the second further additive is a phenylarylamine, wherein the amine is only substituted with a phenyl and an C₆-C₁₀-aryl and the phenyl or the C₆-C₁₀-aryl is alkylated, or a phosphite, which is an ester of at least one aliphatic alcohol having at least one primary hydroxyl group alcohol. Very preferably, the first further additive is a phenolic antioxidant, which is an ester of 3-(3,5-ditert-butyl-4-hydroxy-phenyl)propanoic acid, and the second further additive is a phenylarylamine, wherein the amine is only substituted with a phenyl and an C₆-C₁₀-aryl and the phenyl or the C₆-C₁₀-aryl is alkylated, or a phosphite, which is an ester of at least one aliphatic alcohol having at least one primary hydroxyl group alcohol. Most preferably, the first further additive is a phenolic antioxidant, which is an ester of 3-(3,5-ditert-butyl-4-hydroxy-phenyl)propanoic acid, and the second further additive is a phenylarylamine, wherein the amine is only substituted with a phenyl and an C₆-C₁₀-aryl and the phenyl or the C₆-C₁₀-aryl is alkylated.

Preferred is a composition, which comprises additionally
(c) a first further additive,
(d) a second further additive, which is different to the first further additive.

Preferred is a composition, which comprises
(c) a first further additive, and the first further additive is a phenolic antioxidant, and
(d) a second further additive, and the second further additive is an aromatic amine or a phosphite different to formula I.

Preferred is a composition, which comprises
(c) a first further additive, and the first further additive is a phenolic antioxidant, which is an ester of 3-(3,5-ditert-butyl-4-hydroxy-phenyl)propanoic acid or an ester of 3-(3-tertbutyl-4-hydroxy-5-methyl-phenyl)propanoic acid, and
(d) a second further additive, and the second further additive is a phenylarylamine, wherein the amine is only substituted with a phenyl and an C₆-C₁₀-aryl and the phenyl or the C₆-C₁₀-aryl is alkylated, or a phosphite, which is an ester of at least one aliphatic alcohol having at least one primary hydroxyl group alcohol.

The weight ratio between component (b), i.e. a compound of formula I, and component (d), i.e. the second further additive, is preferably from 0.5 to 2. More preferably, the weight ratio is from 0.7 to 1.5, most preferably 0.8 to 1.2 and very preferably 0.9 to 1.1.

Preferably, the weight ratio between component (b), i.e. a compound of formula I, and component (c), i.e. the first further additive, is from 0.08 to 2, and the weight ratio between component (b) and component (d) is from 0.5 to 2.

Preferred is a composition, wherein the weight ratio between component (b) and component (d) is from 0.5 to 2.

Preferred is a composition, which comprises
(a) a polyurethane foam or a polyether polyol,
(b) a compound of formula I
(c) optionally a first further additive,
(d) optionally a second further additive, which is different to the first further additive,
wherein the polyurethane foam is obtained from the reaction of a polyisocyanate reactant and a polyol reactant in a reaction mixture, wherein the reaction mixture prior to the reaction comprises the polyisocyanate reactant, the polyol reactant and optionally water, a carboxylic acid or a blowing agent and optionally a surfactant and optionally a catalyst and optionally a crosslinker and optionally a chain extender.

Preferred is a composition, which comprises
(a) a polyurethane foam or a polyether polyol,
(b) a compound of formula I, wherein R¹ is C₁-alkyl,
(c) optionally a first further additive,
(d) optionally a second further additive, which is different to the first further additive,
wherein the polyurethane foam is obtained from the reaction of a polyisocyanate reactant and a polyol reactant in a reaction mixture, wherein the reaction mixture prior to the reaction comprises the polyisocyanate reactant, the polyol reactant and optionally water, a carboxylic acid or a blowing agent and optionally a surfactant and optionally a catalyst and optionally a crosslinker and optionally a chain extender.

Preferred is a composition, which comprises
(a) a polyurethane foam,
(b) a compound of formula I, wherein R¹ is C₁-alkyl,
(c) optionally a first further additive,
(d) optionally a second further additive, which is different to the first further additive,
wherein the polyurethane foam is obtained from the reaction of a polyisocyanate reactant and a polyol reactant in a reaction mixture, wherein the reaction mixture prior to the reaction comprises the polyisocyanate reactant, the polyol reactant and water, a carboxylic acid or a blowing agent and optionally a surfactant and optionally a catalyst and optionally a crosslinker and optionally a chain extender.

Preferred is a composition, which comprises
(a) a polyurethane foam,
(b) a compound of formula I, wherein R¹ is C₁-alkyl,
(c) optionally a first further additive,
(d) optionally a second further additive, which is different to the first further additive,
wherein the polyurethane foam is obtained from the reaction of a polyisocyanate reactant and a polyol reactant in a reaction mixture, wherein the reaction mixture comprises the polyisocyanate reactant, the polyol reactant, water and optionally a surfactant and optionally a catalyst and optionally a crosslinker and optionally a chain extender.

Preferred is a composition, which comprises
(a) a polyurethane foam,
(b) a compound of formula I, wherein R¹ is C₁-alkyl,
(c) optionally a first further additive,
(d) optionally a second further additive, which is different to the first further additive,
wherein the polyurethane foam is obtained from the reaction of a polyisocyanate reactant and a polyol reactant in a reaction mixture, wherein the reaction mixture prior to the reaction comprises the polyisocyanate reactant, the polyol reactant, water, a surfactant and optionally a catalyst and optionally a crosslinker and optionally a chain extender.

Preferred is a composition, which comprises
(a) a polyurethane foam,
(b) a compound of formula I, wherein R¹ is C₁-alkyl,
(c) optionally a first further additive,
(d) optionally a second further additive, which is different to the first further additive,
wherein the polyurethane foam is obtained from the reaction of a polyisocyanate reactant and a polyol reactant in a reaction mixture, wherein the reaction mixture prior to the reaction comprises the polyisocyanate reactant, the polyol reactant, water, a surfactant, a catalyst and optionally a crosslinker and optionally a chain extender.

Preferred is a composition, which comprises
(a) a polyurethane foam,
(b) a compound of formula I, wherein R¹ is C₁-alkyl,
(c) optionally a first further additive,
(d) optionally a second further additive, which is different to the first further additive,
wherein the polyurethane foam is obtained from the reaction of a polyisocyanate reactant and a polyol reactant in a reaction mixture, wherein the reaction mixture prior to the reaction comprises the polyisocyanate reactant, the polyol reactant, water, a surfactant and a catalyst.

In case of a polyurethane foam as component (a), it is possible that the composition is a part of a shaped article or the complete shaped article. Preferably, the composition is the complete shaped article, more preferably the composition is in case of a polyurethane foam a slabstock foam, most preferably a flexible slabstock foam.

Preferred is a composition, wherein the composition is in the form of a shaped article and component a) is a polyurethane foam.

Preferred is a composition, wherein the composition is a part of a shaped article or the complete shaped article and component a) is a polyurethane foam.

Preferred is a composition in the form of a foam, which comprises a) a polyurethane foam and b) a compound of formula I.

Preferred is a composition, which is a foam and comprises a) a polyurethane foam and b) a compound of formula I.

Preferred is a composition, which is a slabstock foam and comprises a) a polyurethane foam and b) a compound of formula I.

Examples for the shaped article are:

1) Floating devices for marine applications.

2) Automotive applications, in particular bumpers, dashboards, rear and front linings, moldings parts under the hood, hat shelf, trunk linings, interior linings, air bag covers, instrument panel, exterior linings, upholstery, interior and exterior trims, door panels, seat backing, exterior panels, cladding, pillar covers, chassis parts, convertible tops, front end module, pressed/stamped parts, side impact protection, sound deadener/insulator and sunroof.

3) Plane furnishings, Railway furnishings.

4) Devices for architecture and design, acoustic quietized systems, shelters.

5) Jacketing for other materials such as steel or textiles, for example cable-jacketing.

6) Electric appliances, in particular washing machines, tumblers, ovens (microwave oven), dishwashers, mixers.

7) Rotor blades, ventilators and windmill vanes, swimming pool covers, pool liners, pond liners, closets, wardrobes, dividing walls, slat walls, folding walls, roofs, shutters (e.g. roller shutters), sealings.

8) Packing and wrapping, isolated bottles.

9) Furniture in general, foamed articles (cushions, mattresses, impact absorbers), foams, sponges, dish clothes, mats.

10) Shoes, soles, insoles, spats, adhesives, structural adhesives, couches.

The above described preferences for a composition comprising a polyurethane foam or a polyether polyol as component (a), a compound of formula I as component (b) and optionally a further first additive as component (c) or optionally a further first additive as component (c) and a second further additive as component (d) are described for a composition. These preferences apply also to the further embodiments of the invention.

A further embodiment of the invention relates to a process for manufacturing a composition, which comprises the step of
(i) incorporating a compound of formula I as component (b) into a polyurethane foam or a polyether polyol as component (a) to obtain the composition.

The polyurethane foam is for example obtained by mixing the polyisocyanate reactant and the polyol reactant to receive the reaction mixture, which is permitted to react. It is possible to employ a two-step technique whereby all or a major portion of the polyol reactant is reacted with the polyisocyanate reactant in a first step to form an isocyanate-terminated prepolymer, which is then reacted with the remaining components in a second step to form a foam. However, it is preferred to employ a one-shot technique wherein all components are contacted and reacted in a single step.

Preferably, the process for manufacturing a composition comprises the step of
(i) incorporating a compound of formula I as component (b) into a polyurethane foam, which comprises the steps of
   (i-F-1) adding the compound of formula I to a starting mixture, which comprises a polyol reactant and is free of a polyisocyanate reactant to obtain a pre-reaction mixture,
   (i-F-2) adding a polyisocyanate reactant to the pre-reaction mixture to obtain the reaction mixture, and
   (i-F-3) reacting the reaction mixture to obtain the composition, which comprises the polyurethane foam, or
   incorporating a compound of formula I into a polyether polyol, which comprises the step of
   (i-P-1) adding the compound of formula (I) to the polyether polyol to obtain the composition, which comprises the polyether polyol.

If added, a first further additive is preferably added prior to adding the polyisocyanate reactant, more preferably to the starting mixture or the pre-reaction mixture.

If added, a second further additive is preferably added prior to adding the polyisocyanate reactant, more preferably to the starting mixture or the pre-reaction mixture.

If added, water or a carboxylic acid is preferably added prior to adding the polyisocyanate reactant, more preferably to the starting mixture or the pre-reaction mixture. If added, a blowing agent is preferably added prior to adding a polyisocyanate reactant or parts or all of the blowing agent together with the polyisocyanate reactant.

If added, a surfactant is preferably added prior to adding the polyisocyanate reactant, more preferably to the starting mixture or the pre-reaction mixture.

If added, a catalyst is preferably added prior to adding the polyisocyanate reactant, more preferably to the starting mixture or the pre-reaction mixture.

If added, a crosslinker is preferably added prior to adding the polyisocyanate reactant, more preferably to the starting mixture or the pre-reaction mixture.

If added, a chain extender is preferably added prior to adding the polyisocyanate reactant, more preferably to the starting mixture or the pre-reaction mixture.

Preferred is a process for manufacturing a composition, which comprises the steps of
(i) incorporating a compound of formula (I) as component (b) into a polyurethane foam or a polyether polyol as component (a) to obtain the composition.

A further embodiment of the invention relates to the use of a compound of formula I, i.e. component (b), for protecting a polyurethane foam or a polyether polyol, i.e. component (a), against degradation. Preferably, protecting is against oxidative, thermal or light-induced degradation. In case of a polyurethane foam as component (a), protecting is preferably against yellowing. In case of a polyurethane foam as component (a), protecting is preferably against scorching. In case of a polyether polyol as component (b), protecting is preferably against oxidative degradation, more preferably against degradation by oxygen at a temperature between 100 and 300° C.

Preferred is the use of a compound of formula I, i.e. component (b), for protecting a polyurethane foam or a polyether polyol, i.e. component (a) against degradation.

Preferred is the use of a compound of formula I, i.e. component (b), for protecting a polyurethane foam against scorching.

A further embodiment of the invention relates to an additive mixture, which comprises the components
(b) a compound of formula I as defined in claim 1, and
(c) a first further additive, which is a phenylarylamine with one nitrogen atom, wherein the nitrogen atom is only substituted with a phenyl and an C₆-C₁₀-aryl and the phenyl or the C₆-C₁₀-aryl is alkylated, or a phosphite, which is an ester of at least one aliphatic alcohol having at least one primary hydroxyl group.

Preferred is an additive mixture, which comprises a first further additive, which is a phenylarylamine with one nitrogen atom, wherein the nitrogen atom is only substituted with a phenyl and an C₆-C₁₀-aryl and the phenyl or the C₆-C₁₀-aryl is alkylated.

Preferred is an additive mixture, which comprises additionally as component (d) a second further additive.

Preferred is an additive mixture, which comprises a first further additive and the first further additive is a phenylarylamine, wherein the amine is only substituted with a phenyl and an C₆-C₁₀-aryl and the phenyl or the C₆-C₁₀-aryl is alkylated, and a second further additive, which is a phenolic antioxidant, which is an ester of 3-(3,5-ditert-butyl-4-hydroxy-phenyl)propanoic acid or an ester of 3-(3-tert-butyl-4-hydroxy-5-methyl-phenyl)propanoic acid.

Preferred is an additive mixture, which comprises a first further additive and the first further additive is a phenylarylamine, wherein the amine is only substituted with a phenyl and an C₆-C₁₀-aryl and the phenyl or the C₆-C₁₀-aryl is alkylated, and a second further additive, which is a phenolic antioxidant, which is an ester of 3-(3,5-ditert-butyl-4-hydroxy-phenyl)propanoic acid.

The invention is illustrated by the non-limiting examples below.

### EXPERIMENTAL PART

Unless the context suggests otherwise, percentages are always by weight. A reported content is based on the content in aqueous solution or dispersion if not stated otherwise.

Stabilizers

Stabilizer 1 is compound (101) as depicted below and obtainable according to example S-3 of WO 2015/121445 A1.

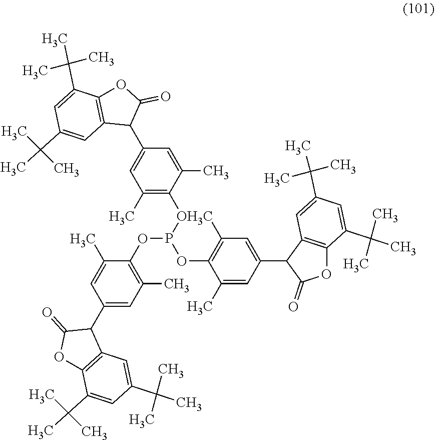 [SMILES: Cc1cc(C2C(=O)Oc3c2cc(C(C)(C)C)cc3C(C)(C)C)cc(C)c1OP(Oc1c(C)cc(C2C(=O)Oc3c2cc(C(C)(C)C)cc3C(C)(C)C)cc1C)Oc1c(C)cc(C2C(=O)Oc3c2cc(C(C)(C)C)cc3C(C)(C)C)cc1C]

Stabilizer 2 is compound (102) as depicted below and obtainable according to example S-5 of WO 2015/121445 A1.

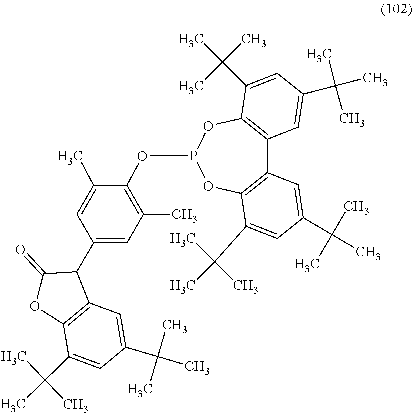 [SMILES: Cc1cc(C2C(=O)Oc3c2cc(C(C)(C)C)cc3C(C)(C)C)cc(C)c1Op1oc2c(C(C)(C)C)cc(C(C)(C)C)cc2c2cc(C(C)(C)C)cc(C(C)(C)C)c2o1]

Stabilizer 3 is compound (103) as depicted below and obtainable according to example S-7 of WO 2015/121445 A1.

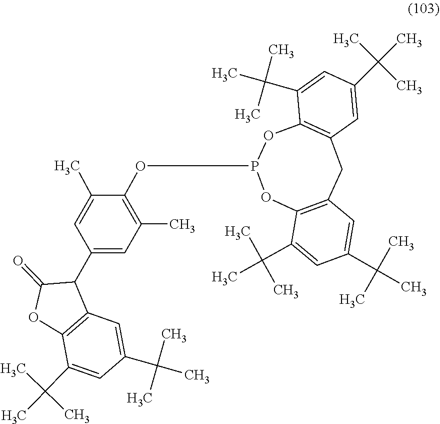 [SMILES: Cc1cc(C2C(=O)Oc3c2cc(C(C)(C)C)cc3C(C)(C)C)cc(C)c1OP1Oc2c(cc(C(C)(C)C)cc2C(C)(C)C)Cc2cc(C(C)(C)C)cc(C(C)(C)C)c2O1]

Stabilizer 4 is compound (104) as depicted below and obtainable according to example S-8 of WO 2015/121445 A1.

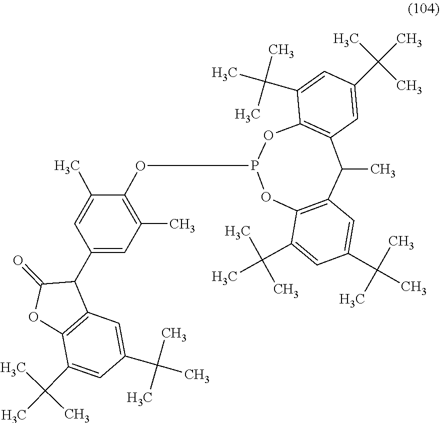 [SMILES: Cc1cc(C2C(=O)Oc3c2cc(C(C)(C)C)cc3C(C)(C)C)cc(C)c1OP1Oc2c(cc(C(C)(C)C)cc2C(C)(C)C)C(C)c2cc(C(C)(C)C)cc(C(C)(C)C)c2O1]

Stabilizer 5 is compound (105) as depicted below and obtainable according to example P-2 of WO 2017/025431 A1.

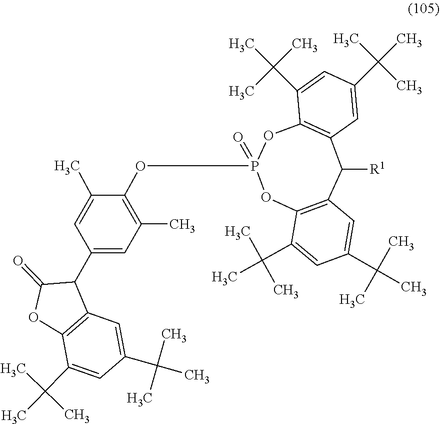

Stabilizer 6 is compound (106) as depicted below and obtainable according to EP 0871066 A1 with its compound No. 1-30.

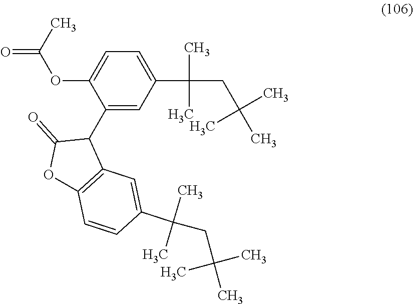 [SMILES: CC(=O)Oc1ccc(C(C)(C)CC(C)(C)C)cc1C1C(=O)Oc2ccc(C(C)(C)CC(C)(C)C)cc21]

Stabilizer 7 is the product of a reaction of 5,7-ditert-butyl-3-[4-(2-hydroxyethoxy)phenyl]-3H-benzofuran-2-one and of ε-caprolactone, contains compound (107) as depicted below and is obtainable according to example 3 of WO 2006/065829 A1.

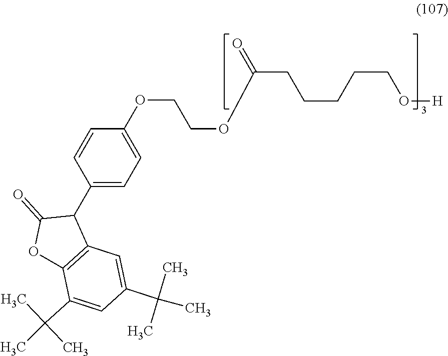

Stabilizer 8 is the product of a transesterification of 3-(3,5-di-tert-butyl-4-hydroxyphenyl)-propionic acid methyl ester with polyethylene glycol 200, contains compound (108) as depicted below and is obtainable according to example 1a of WO 2010/003813 A1.

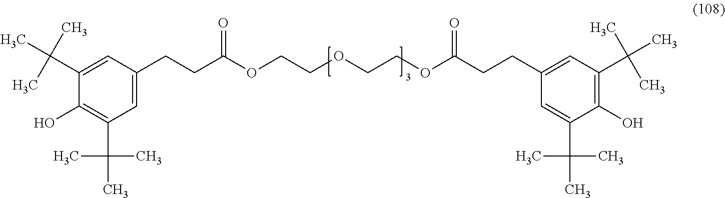

Stabilizer 9 is Irganox 245 (TM BASF), which contains compound (109) as depicted below and is commercially obtainable.

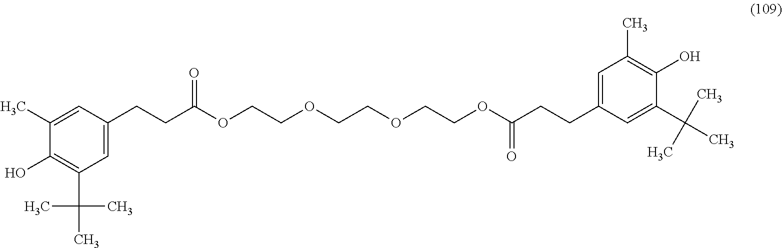 [SMILES: Cc1cc(CCC(=O)OCCOCCOCCOC(=O)CCc2cc(C)c(O)c(C(C)(C)C)c2)cc(C(C)(C)C)c1O]

Stabilizer 10 is Irganox E 201 (TM BASF), which is a commercially available vitamin E and contains compound (110) [=2,5,7,8-tetramethyl-2-[4,8,12-trimethyltridecyl]chroman-6-ol] as depicted below.

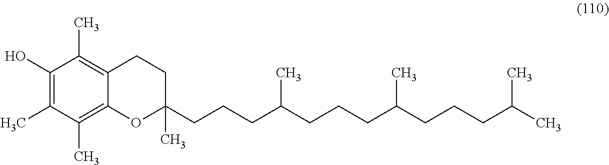 [SMILES: Cc1c(C)c2c(c(C)c1O)CCC(C)(CCCC(C)CCCC(C)CCCC(C)C)O2]

Stabilizer 11 is Irganox 1010 (TM BASF), which contains compound (111) as depicted below and is commercially available.

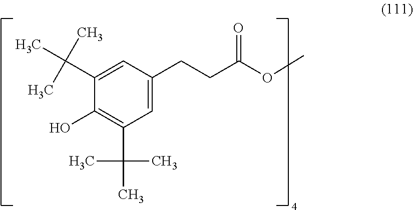

Stabilizer 12 is Irganox 1135 (TM BASF), which contains compound (112) [=3-(3,5-di-tert-butyl-4-hydroxy-phenyl)-propionic acid iso-octyl ester] as depicted below and is commercially available.

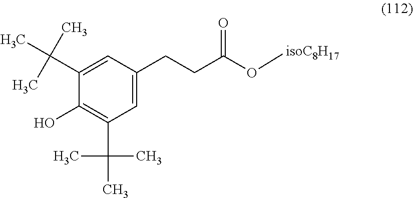

Stabilizer 13 is Irganox 1076 (TM BASF), which contains compound (113) as depicted below and is commercially available.

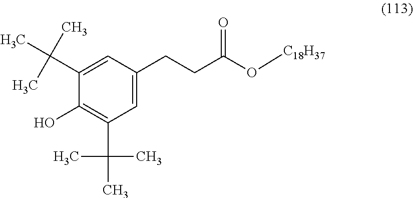

Stabilizer 14 is Irganox 5057 (TM BASF), which is a technical mixture obtained by the reaction of diphenylamine with diisobutylene, comprising
(A)₅₀₅₇ diphenylamine;
(B)₅₀₅₇ 4-tert-butyldiphenylamine;
(C)₅₀₅₇ compounds of the group
   i) 4-tert-octyldiphenylamine,
   ii) 4,4′-di-tert-butyldiphenylamine,
   iii) 2,4,4′-tris-tert-butyldiphenylamine,
(D)₅₀₅₇ compounds of the group
   i) 4-tert-butyl-4′-tert-octyldiphenylamine,
   ii) o,o′, m,m′, or p,p′-di-tert-octyldiphenylamine,
   iii) 2,4-di-tert-butyl-4′-tert-octyldiphenylamine,
(E)₅₀₅₇ compounds of the group
   i) 4,4′-di-tert-octyldiphenylamine,
   ii) 2,4-di-tert-octyl-4′-tert-butyldiphenylamine, and
      wherein not more than 5% by weight of component (A)₅₀₅₇, 8 to 15% by weight of component (B)₅₀₅₇, 24 to 32% by weight of component (C)₅₀₅₇, 23 to 34% by weight of component (D)₅₀₅₇ and 21 to 34% by weight of component (E)₅₀₅₇ are present. It is commercially available.

Stabilizer 15 is Irganox L06 (TM BASF), which contains compound (115) [═N-[(1,1,3,3-tetramethylbutyl)phenyl]-1-napthalenamine] as depicted below and is commercially available.

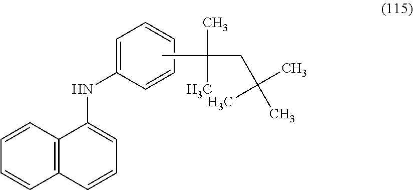

Stabilizer 16 is Irgafos 126 (TM BASF), which contains compound (116) and is commercially available.

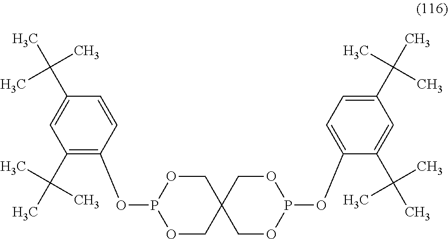 [SMILES: CC(C)(C)c1ccc(OP2OCC3(CO2)COP(Oc2ccc(C(C)(C)C)cc2C(C)(C)C)OC3)c(C(C)(C)C)c1]

The other used materials are commercially available for example from Aldrich Inc. or BASF SE.

Stabilizer 17 is Irgafos 168 (TM BASF), which contains compound (117) and is commercially available.

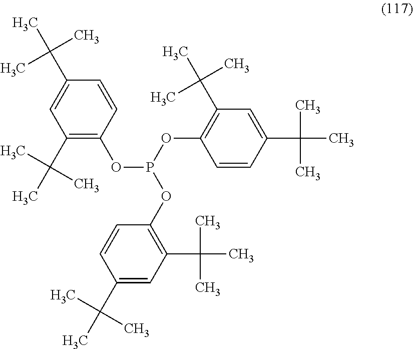 [SMILES: CC(C)(C)c1ccc(OP(Oc2ccc(C(C)(C)C)cc2C(C)(C)C)Oc2ccc(C(C)(C)C)cc2C(C)(C)C)c(C(C)(C)C)c1]

### Application

### Example A-1: Stabilization of a Polyurethane Soft Foam Based on a Polyether Polyol

Preparation of polyurethane soft foams based on a polyether polyol with 4.8 parts water based on 100 parts polyol and an isocyanate index of 107 (isocyanate index meaning herein 100 times the ratio between isocyanate equivalents and active hydrogen equivalents in the polyol and water with index 100 indicating a stoichiometry 1 to 1 and with index 107 indicating a 7% excess of isocyanate equivalents):

0.05 g of stabilizer product according to the invention as described in table T-A-1 (0.03 parts based on 100 parts of polyol) are dissolved in 157.1 g of a trifunctional polyether polyol predominantly containing secondary hydroxyl groups, with a number average molecular weight (Mₙ) of 3500 D, with an OH Number of 48 and containing already stabilizers (0.386 parts stabilizer 12 and 0.104 parts stabilizer 14). 9.84 g of a solution consisting of 1.92 g Tegostab BF 2370 (TM Evonik Industries; surfactant based on polysiloxane), 0.24 g Tegoamin 33 (TM Evonik Industries; general purpose gelling catalyst based on triethylene diamine) and 7.68 g of deionized water are added and the reaction mixture is stirred vigorously for 10 seconds at 2600 rpm. 0.31 g Kosmos 29 (TM Evonik Industries; catalyst based on stannous octoate) dissolved with 2.9 g of the polyol are then added and the reaction mixture is again stirred vigorously for 18 seconds at 2600 rpm. 92.19 g of isocyanate TDI 80 (mixture containing 80% toluylene-2,4-diisocyanate and 20% toluylene-2,6-diisocyanate isomers) is then added with continuous stirring for 5 to 7 seconds at 2600 rpm. The mixture is then poured into a 20×20×20 cm cake-box and an exothermic foaming reaction takes place as indicated by an increase of temperature. The foam buns are cooled and stored at room temperature for 24 hours. All prepared foam buns show a comparable initial white colour. The density of the foam is 20 kg/m³ at 20° C. and 101.3 kPa.

Anti-Scorch Testing:

Scorch resistance is determined by static heat aging, i.e. static Alu-block test. The foam buns are cut into thin tubes (2 cm thick, 1.5 cm in diameter). From each foam bun, a thin tube is taken as a foam sample. The foam sample is heated in an aluminum block. The temperature is kept for 30 min at the temperature of 190° C. The scorch resistance is assessed by measuring the colour of the foam sample after aging. The measured colour is reported in terms of Yellowness Index (YI) determined on the foam sample in accordance with the ASTM 1926-70 Yellowness Test. Low YI values denote little discoloration, high YI values severe discoloration of the samples. The whiter a foam sample remains, the better the foam sample is stabilized.

TABLE T-A-1
Results of static Alu-block ageing of polyurethane soft foams

| | stabilizer composition | overall | YI after 30 |
|---|---|---|---|
| Foam | (parts based on 100 | parts of | min exposure |
| No. | parts polyether polyol) | stabilizer | at 190° C. |
| A-1-1 ^{a)} | 0.386 parts of stabilizer 12 | 0.49 | 11 |
| | 0.104 parts of stabilizer 14 | | |
| A-1-2 ^{a)} | 0.386 parts of stabilizer 12 | 0.52 | 10.6 |
| | 0.104 parts of stabilizer 14 | | |
| | 0.03 parts of stabilizer 1 | | |
| A-1-3 ^{a)} | 0.386 parts of stabilizer 12 | 0.52 | 7.7 |
| | 0.104 parts of stabilizer 14 | | |
| | 0.03 parts of stabilizer 2 | | |
| A-1-4 ^{b)} | 0.386 parts of stabilizer 12 | 0.52 | 2.5 |
| | 0.104 parts of stabilizer 14 | | |
| | 0.03 parts of stabilizer 3 | | |
| A-1-5 ^{b)} | 0.386 parts of stabilizer 12 | 0.52 | 2.4 |
| | 0.104 parts of stabilizer 14 | | |
| | 0.03 parts of stabilizer 4 | | |
| A-1-6 ^{a)} | 0.386 parts of stabilizer 12 | 0.52 | 9.2 |
| | 0.104 parts of stabilizer 14 | | |
| | 0.03 parts of stabilizer 6 ^{c)} | | |

Footnotes:
^{a)} comparative
^{b)} according to the invention
^{c)} stabilizer 6 is a benzofuranone substituted with an acetoxy-substituted phenyl,
which is applied in example 1 of EP 1291384 A1 for stabilization of a polyurethane soft foam based on a polyether polyol

The data of table T-A-1 show that stabilizer 3 (a specific mono-benzofuranone phosphite) and stabilizer 4 (a specific mono-benzofuranone phosphite) show an improved anti-scorch activity in comparison to no additional stabilizer, to stabilizer 1 (a specific tris-benzofuranone phosphite), to stabilizer 2 (a specific mono-benzofuranone phosphite) and to stabilizer 6 (a benzofuranone substituted with an acetoxy-substituted phenyl), when added to stabilizer 12 (a mono-phenolic antioxidant) and stabilizer 14 (an alkylated diphenyl amine). Foam sample A-1-5 shows the lowest discoloration, which indicates that the stabilizer 4 gives the highest anti-scorch performance.

### Example A-2: Stabilization of a Polyurethane Soft Foam Based on a Polyether Polyol

Preparation of polyurethane soft foams based on a polyether polyol with 7 parts water based on 100 parts polyol and an isocyanate index 110 (meaning of index as described at example A-1): 0.12 g or 1.20 g of a stabilizer composition (0.1-1 parts based on 100 parts of polyol) according to the invention are dissolved in 108.35 g of a trifunctional polyether polyol predominantly containing secondary hydroxyl groups, with a number average molecular weight (Mᵣ) of 3500 D, with an OH Number of 48 and containing no stabilizers. 10.07 g of a solution consisting of 2.20 g Tegostab BF 2370 (TM Evonik Industries; surfactant based on polysiloxane), 0.17 g Tegoamin 33 (TM Evonik Industries; general purpose gelling catalyst based on triethylenediamine) and 7.7 g of deionized water are added and the reaction mixture is stirred vigorously for 10 seconds at 2600 rpm. 0.33 g Kosmos 29 (TM Evonik Industries; catalyst based on stannous octoate) dissolved with 1.65 g of the polyol are then added and the reaction mixture is again stirred vigorously for 18 seconds at 2600 rpm. 90.86 g of isocyanate TDI80 (mixture containing 80% toluylene-2,4-diisocyanate and 20% toluylene-2,6-diisocyanate isomers) is then added with continuous stirring for 5 to 7 seconds at 2600 rpm. The mixture is then poured into a 20×20×20 cm cake-box and an exothermic foaming reaction takes place as indicated by an increase of temperature. The foam buns are cooled down and stored at room temperature for 24 hours. All prepared foam buns show a comparable initial whit colour. The density of the foam is 16 kg/m³ at 2° C. and 101.3 kPa.

TABLE T-A-2
Results of static Alu-block ageing of polyurethane soft foams

| | stabilizer composition | overall | YI after 30 |
|---|---|---|---|
| Foam | (parts based on 100 | parts of | min exposure |
| No. | parts polyether polyol) | stabilizer | at 190° C. |
| A-2-1 ^{a)} | no stabilizer added | — | 21.7 |
| A-2-2 ^{a)} | 0.1 parts of stabilizer 6 ^{c)} | 0.1 | 8.9 |
| A-2-3 ^{b)} | 0.1 parts of stabilizer 4 | 0.1 | 8.0 |
| A-2-4 ^{a)} | 0.1 parts of stabilizer 7 ^{d)} | 0.1 | 15.3 |
| A-2-5 ^{a)} | 0.1 parts of stabilizer 5 | 0.1 | 8.9 |
| A-2-6 ^{a)} | 1 part of stabilizer 6 ^{c)} | 1 | 6.1 |
| A-2-7 ^{b)} | 1 part of stabilizer 4 | 1 | 3.3 |
| A-2-8 ^{a)} | 1 part of stabilizer 7 ^{d)} | 1 | 4.5 |
| A-2-9 ^{a)} | 1 part of stabilizer 5 | 1 | 3.7 |

Footnotes:
^{a)} comparative
^{b)} according to the invention
^{c)} stabilizer 6 is a benzofuranone substituted with an acetoxy-substituted phenyl,
which is applied in example 1 of EP 1291384 A1 for stabilization of a polyurethane soft foam based on a polyether polyol
^{d)} stabilizer 7 is a benzofuranone substituted with an alkoxy-substituted phenyl,
which is applied in examples of WO 2006/065829 A1 for stabilization of a polyurethane soft foam based on a polyether polyol

The data of table T-A-2 show that stabilizer 4 (a specific mono-benzofuranone phosphite) shows an anti-scorch activity already in the absence of additional stabilizers. When the loading is increased from 0.1 parts based on 100 parts of polyol towards 1 part based on 100 parts of polyol, stabilizer 4 gives still the highest anti-scorch performance in the present comparison.

### Example A-3: Stabilization of a Polyurethane Soft Foam Based on a Polyether Polyol

Preparation of polyurethane soft foams based on a polyether polyol with 4.8 parts water based on 100 parts polyol and an isocyanate index 107 (meaning of index as described at example A1): 0.16 g of stabilizer 4 (0.1 parts based on 100 parts of polyol) as described in table T-A-3 is dissolved in 157.1 g of a trifunctional polyether polyol predominantly containing secondary hydroxyl groups, with a number average molecular weight (Mₙ) of 3500 D, with an OH Number of 48 and containing no stabilizers. For foam No. A-3-1, no stabilizer 4 is added. For foams No. A-3-3 to A-3-9, 0.08 g of stabilizer 4 (0.05 parts based on 100 parts of polyol) is added. 9.84 g of a solution consisting of 1.92 g Tegostab BF 2370 (TM Evonik Industries; surfactant based on polysiloxane), 0.24 g Tegoamin 33 (TM Evonik Industries; general purpose gelling catalyst based on triethylene diamine) and 7.68 g of deionized water are added and the reaction mixture is stirred vigorously for 10 seconds at 2600 rpm. 0.31 g Kosmos 29 (TM Evonik Industries; catalyst based on stannous octoate) dissolved with 2.9 g of the polyol are then added and the reaction mixture is again stirred vigorously for 18 seconds at 2600 rpm. 92.19 g of isocyanate TDI 80 (mixture containing 80% toluylene-2,4-diisocyanate and 20% toluylene-2,6-diisocyanate isomers) is then added with continuous stirring for 5 to 7 seconds at 2600 rpm. The mixture is then poured into a 20×20×20 cm cake-box and an exothermic foaming reaction takes place as indicated by an increase of temperature. The foam buns are cooled and stored at room temperature for 24 hours. All prepared foam buns show a comparable initial white colour. The density of the foam is 20 kg/m³ at 20° C. and 101.3 kPa.

TABLE T-A-3
Results of static Alu-block ageing of polyurethane soft foams

| | stabilizer composition | overall | YI after 30 |
|---|---|---|---|
| Foam | (parts based on 100 | parts of | min exposure |
| No. | parts polyether polyol) | stabilizer | at 190° C. |
| A-3-1 ^{a)} | no stabilizer added | — | 29.5 |
| A-3-2 ^{b)} | 0.1 parts of stabilizer 4 | 0.1 | 10 |
| A-3-3 ^{b)} | 0.05 parts of stabilizer 4 | 0.1 | 8.5 |
| | 0.05 parts of stabilizer 14 | | |
| A-3-4 ^{b)} | 0.05 parts of stabilizer 4 | 0.1 | 6.8 |
| | 0.05 parts of stabilizer 15 | | |
| A-3-5 ^{b)} | 0.05 parts of stabilizer 4 | 0.45 | 3.1 |
| | 0.40 parts of stabilizer 8 | | |
| A-3-6 ^{b)} | 0.05 parts of stabilizer 4 | 0.45 | 4.1 |
| | 0.40 parts of stabilizer 11 | | |
| A-3-7 ^{b)} | 0.05 parts of stabilizer 4 | 0.45 | 3.2 |
| | 0.40 parts of stabilizer 13 | | |
| A-3-8 ^{b)} | 0.05 parts of stabilizer 4 | 0.45 | 3.2 |
| | 0.40 parts of stabilizer 12 | | |
| A-3-9 ^{b)} | 0.05 parts of stabilizer 4 | 0.45 | 4.8 |
| | 0.40 parts of stabilizer 9 | | |

Footnotes:
^{a)} comparative
^{b)} according to the invention

The data of table T-A-3 show that a combination of stabilizer 4 (a specific mono-benzofuranone phosphite) with stabilizer 14 (an alkylated diphenylamine) or stabilizer 15 (an alkylated naphthylphenylamine) reduces scorch discoloration even further than by the same amount of only stabilizer 4. The data of table T-A-3 show further that a combination of stabilizer 4 (a specific mono-benzofuranone phosphite) and stabilizer 8 (a bis-phenolic antioxidant), stabilizer 9 (a bisphenolic antioxidant), stabilizer 11 (a tetrakis-phenolic antioxidant), stabilizer 12 (a mono-phenolic antioxidant) or stabilizer 13 (a mono-phenolic antioxidant) reduces discoloration to an extent dependent on the phenolic antioxidant.

### Example A-4: Stabilization of a Polyurethane Soft Foam Based on a Polyether Polyol

Preparation of polyurethane soft foams based on a polyether polyol with 7 parts water based on 100 parts polyol and an isocyanate index 110 (meaning of index as described at example A-1): 0.54 g of a stabilizer composition (0.45 parts based on 100 parts of polyol) as described in table T-A-4 are dissolved in 108.35 g of a trifunctional polyether polyol predominantly containing secondary hydroxyl groups, with a number average molecular weight of 3500 D, with an OH Number of 48 and containing no stabilizers. For foam No. A-3-1, no stabilizer is added. 10.07 g of a solution consisting of 2.20 g Tegostab BF2370 (TM Evonik Industries; surfactant based on polysiloxane), 0.17 Tegoamin 33 (TM Evonik Industries; general purpose gelling catalyst based on triethylene diamine) and 7.7 g of deionized water are added and the reaction mixture is stirred vigorously for 10 seconds at 2600 rpm. 0.33 g Kosmos 29 (TM Evonik Industries; catalyst based on stannous octoate) dissolved with 1.65 g of the polyol are then added and the reaction mixture is again stirred vigorously for 18 seconds at 2600 rpm. 90.86 g of isocyanate TDI 80 (mixture containing 80% toluylene-2,4-diisocyanate and 20% toluylene-2,6-diisocyanate isomers) is then added with continuous stirring for 5 to 7 seconds at 2600 rpm. The mixture is then poured into a20×20×20 cm cake-box and an exothermic foaming reaction takes place as indicated by an increase of temperature. The foam buns are cooled down and stored at room temperature for 24 hours. All prepared foam buns show a comparable initial white colour. The density of the foam is 16 kg/m³ at 20° C. and 101.3 kPa.

TABLE T-A-4
Results of static Alu-block ageing of polyurethane soft foams

| | stabilizer composition | overall | YI after 30 |
|---|---|---|---|
| Foam | (parts based on 100 | parts of | min exposure |
| No. | parts polyether polyol) | stabilizer | at 190° C. |
| A-4-1 ^{a)} | no stabilizer added | — | 29.5 |
| A-4-2 ^{b)} | 0.35 parts of stabilizer 8 | 0.45 | 6.3 |
| | 0.05 parts of stabilizer 10 | | |
| | 0.05 parts of stabilizer 4 | | |
| A-4-3 ^{b)} | 0.35 parts stabilizer 8 | 0.45 | 3.6 |
| | 0.05 parts of stabilizer 15 | | |
| | 0.05 parts of stabilizer 4 | | |
| A-4-4 ^{b)} | 0.35 parts of stabilizer 8 | 0.45 | 2.7 |
| | 0.05 parts of stabilizer 16 | | |
| | 0.05 parts of stabilizer 4 | | |
| A-4-5 ^{b)} | 0.35 parts of stabilizer 13 | 0.45 | 3.1 |
| | 0.05 parts of stabilizer 16 | | |
| | 0.05 parts of stabilizer 4 | | |
| A-4-6 ^{b)} | 0.320 parts of stabilizer 12 | 0.45 | 2.9 |
| | 0.096 parts of stabilizer 14 | | |
| | 0.032 parts of stabilizer 4 | | |
| A-4-7 ^{b)} | 0.320 parts of stabilizer 8 | 0.45 | 3.9 |
| | 0.096 parts of stabilizer 14 | | |
| | 0.032 parts of stabilizer 4 | | |

Footnotes:
^{a)} comparative
^{b)} according to the invention

The data of table T-A-4 show that ternary combinations including stabilizer 4 (a specific mono-benzofuranone phosphite) provide anti-scorch performance.

### Example A-5: Stabilization of a Polyether Polyol

Preparation of a Stabilized Polyether Polyol:

0.45 g of a composition of stabilizers (0.45 parts based on 100 parts of polyol) as depicted in table T-A-5 are dissolved in 100 g of a trifunctional polyether polyol predominantly containing secondary hydroxyl groups, with a number average molecular weight (Mᵣ) of 3500 D, with an OH number of 48 and containing no stabilizer.

Oxidation Resistance Testing:

The oxidation resistance of an obtained stabilized polyether polyol sample is determined by differential scanning calorimetry (DSC). The sample is heated starting at 50′C with a heating rate of 5° C./min under oxygen until 200° C. is reached. The appearance of an exothermic peak indicates the beginning of a thermo-oxidative reaction. The temperature at the onset of the exothermic peak is noted. A better stabilized sample is characterized by a higher temperature for the onset. The results are depicted in table T-A-5.

TABLE T-A-5
Results of oxidation resistance testing of stabilized polyether polyols

| | stabilizer composition | overall | onset |
|---|---|---|---|
| Foam | (parts based on 100 | parts of | temperature |
| No. | parts polyether polyol) | stabilizer | [° C.] |
| A-5-1 ^{b)} | 0.35 parts of stabilizer 8 | 0.45 | 201 |
| | 0.05 parts of stabilizer 10 | | |
| | 0.05 parts of stabilizer 4 | | |
| A-5-2 ^{b)} | 0.35 parts stabilizer 8 | 0.45 | 189 |
| | 0.05 parts of stabilizer 15 | | |
| | 0.05 parts of stabilizer 4 | | |
| A-5-3 ^{b)} | 0.35 parts of stabilizer 8 | 0.45 | 189 |
| | 0.05 parts of stabilizer 16 | | |
| | 0.05 parts of stabilizer 4 | | |
| A-5-4 ^{b)} | 0.35 parts of stabilizer 13 | 0.45 | 183 |
| | 0.05 parts of stabilizer 16 | | |
| | 0.05 parts of stabilizer 4 | | |
| A-5-5 ^{b)} | 0.320 parts of stabilizer 12 | 0.45 | 197 |
| | 0.096 parts of stabilizer 14 | | |
| | 0.032 parts of stabilizer 4 | | |
| A-5-6 ^{b)} | 0.320 parts of stabilizer 8 | 0.45 | 198 |
| | 0.096 parts of stabilizer 14 | | |
| | 0.032 parts of stabilizer 4 | | |

Footnotes:
^{a)} comparative
^{b)} according to the invention

The data of table T-A-5 show that ternary combinations comprising stabilizer 4 (a specific mono-benzofuranone phosphite) stabilize the polyether polyol.

### Example A-6: Stabilization of a Molded Thermoplastic Polyurethane Based on a Polyether Polyol

Preparation of Molded Thermoplastic Polyurethane Test Panels (Plaques)

Compounding

3.0 kg of a commercial thermoplastic polyurethane (TPU, based on an aliphatic polyether polyol, extrusion and injection molding grade, shore D value of 55, with a content of 0.25 parts by weight of stabilizer 11 and 0.05 parts by weight of stabilizer 17, each weight parts based on 100 parts of thermoplastic polyurethane, in the physical form of pellets) are ground in a cryogenic mill and dried under vacuum at 80° C. until water content is below 0.05% by weight of the thermoplastic polyurethane. The obtained powder is mixed to homogeneity in a tumbler mixer after addition of 0.05 parts by weight of a further stabilizer according to table T-A-6-1/T-A-6-2 or no additional stabilizer for reference. The obtained blend is then immediately extruded in a twin-screw extruder Berstorff ZE 25×32D (TM Berstorff) at a temperature of at most 220° C. The obtained granulate is dried again under dry air at 80° C. until the water content is below to 0.03% by weight of the granules.

Injection Molding

Test panels (plaques) of the size 64 mm×44 mm×2 mm are molded from the obtained granulates by means of an injection-molding machine, i.e. an Engel HL 60 (TM Engel), at a temperature of at most 230° C. (mold temperature: 40° C.). The density of the test panels (plaques) is 1170 kg/m³ (1.17 g/cm³) at 20° C. and 101.3 kPa.

Thermo-Oxidation Resistance Test

The thermo-oxidation resistance of the manufactured thermoplastic polyurethane test panels is tested by putting them in an air-circulating oven at the temperature of 120° C. A plaque's initial color before heat ageing and its discoloration after exposure in the oven is measured and compared. Results are depicted in table T-A-6-1.

Accelerated Weathering Resistance Test

The light stability and accelerated weathering resistance of the manufactured thermoplastic polyurethane test panels is tested by exposing them in a Weather-Ometer Ci4000 (TM Atlas) according to the standard D27-1911. The surface discoloration is then measured (Delta E). Results are described in table T-A-6-2.

TABLE T-A-6-1
Results of thermo-oxidation resistance test

| | stabilizer composition | delta E after |
|---|---|---|
| Test panel | (parts based on 100 parts | oven ageing at |
| No. | molded polyurethane) | 120° C. for 48 h |
| A-6-1-1 ^{a)} | 0.25 parts of stabilizer 11 ^{b)} | 3.04 |
| | 0.05 parts of stabilizer 17 ^{b)} | |
| A-6-1-2 ^{a)} | 0.25 parts of stabilizer 11 ^{b)} | 3.02 |
| | 0.05 parts of stabilizer 17 ^{b)} | |
| | 0.05 parts of stabilizer 6 ^{c), d)} | |
| A-6-1-3 ^{a)} | 0.25 parts of stabilizer 11 ^{b)} | 3.48 |
| | 0.05 parts of stabilizer 17 ^{b)} | |
| | 0.05 parts of stabilizer 7 ^{c), e)} | |
| A-6-1-4 ^{a)} | 0.35 parts of stabilizer 11 ^{b)} | 2.97 |
| | 0.05 parts of stabilizer 17 ^{b)} | |
| | 0.05 parts of stabilizer 4 ^{c)} | |

Footnotes:
^{a)} comparative
^{b)} contained prior compounding
^{c)} added during compounding
^{d)} stabilizer 6 is a benzofuranone substituted with an acetoxy-substituted phenyl,
which is applied in example 1 of EP 1291384 A1 for stabilization of a polyurethane soft foam based on a polyether polyol
^{e)} stabilizer 7 is a benzofuranone substituted with an alkoxy-substituted phenyl,
which is applied in examples of WO 2006/065829 A1 for stabilization of a polyurethane soft foam based on a polyether polyol

TABLE T-A-6-2
Results of accelerated weathering resistance test

| | stabilizer composition | delta E after exposure | | |
|---|---|---|---|---|
| Test panel | (parts based on 100 parts | to D27-1911 for | | |
| No. | molded polyurethane) | 1179 h | 1522 h | 2016 h |
| A-6-2-1 ^{a)} | 0.25 parts of stabilizer 11 ^{b)} | 9.89 | 10.59 | 9.77 |
| | 0.05 parts of stabilizer 17 ^{b)} | | | |
| A-6-2-2 ^{a)} | 0.25 parts of stabilizer 11 ^{b)} | 9.08 | 9.57 | 8.14 |
| | 0.05 parts of stabilizer 17 ^{b)} | | | |
| | 0.05 parts of stabilizer 6 ^{c), d)} | | | |
| A-6-2-3 ^{a)} | 0.25 parts of stabilizer 11 ^{b)} | 9.85 | 10.06 | 9.62 |
| | 0.05 parts of stabilizer 17 ^{b)} | | | |
| | 0.05 parts of stabilizer 7 ^{c), e)} | | | |
| A-6-2-4 ^{a)} | 0.35 parts of stabilizer 11 ^{b)} | 9.23 | 9.62 | 9.25 |
| | 0.05 parts of stabilizer 17 ^{b)} | | | |
| | 0.05 parts of stabilizer 4 ^{c)} | | | |

Footnotes:
see footnotes at table T-A-6-1

The data of tables T-A-6-1 and T-A-6-2 show that stabilizer 4 (a specific mono-benzofuranone phosphite) is better than stabilizer 6 (a benzofuranone substituted with an acetoxy-substituted phenyl) at the thermo-oxidation resistance test of the molded polyurethane test panel, whereas stabilizer 4 is worse than stabilizer 6 at the accelerated weathering resistance test of the molded polyurethane test panel. Both testings occur in the presence of stabilizer 11 (a tetrakis-phenolic antioxidant) and stabilizer 11 (a phosphite, which is an ester without an aliphatic alcohol). Stabilizer 7 (a benzofuranone substituted with an alkoxy-substituted phenyl) is inferior to stabilizer 4 and stabilizer 6 in both testings. These results show that the performance difference between stabilizer 4 and stabilizer 6 in a polyurethane foam is not seen in a molded thermoplastic polyurethane test panel.

Preferred is the following set of clauses 1 to 19:

1. A composition, which comprises the components
(a) a polyurethane foam; and
(b) a compound of formula I

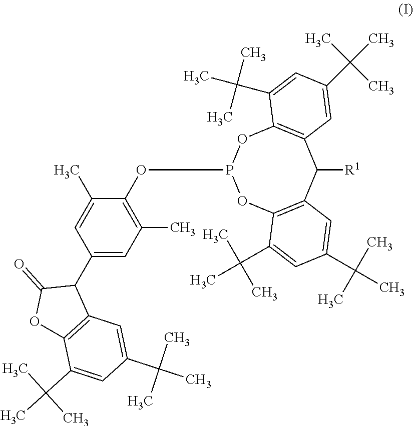

wherein R¹ is H or methyl.

2. A composition according to clause 1, wherein the composition is in the form of a shaped article.

3. A composition according to clause 1 or 2, wherein at formula I R¹ is methyl.

4. A composition according to any preceding clause, wherein the polyurethane foam is obtained from the reaction of a polyisocyanate reactant and a polyol reactant in a reaction mixture, and 60 to 100 parts by weight of the polyol reactant based on 100 parts by weight of the polyol reactant is a polyether polyol.

5. A composition to any preceding clause, wherein the polyurethane foam is obtained from the reaction of a polyisocyanate reactant and a polyol reactant in a reaction mixture, and the reaction mixture contains prior to the reaction water, a carboxylic acid or a blowing agent.

6. A composition according to any preceding clause, wherein the polyurethane foam has a density between 5 to 500 kg/m³ at 20° C. and 101.3 kPa.

7. A composition according to any preceding clause, wherein the composition is a foam.

8. A composition according to any preceding clause, wherein the polyurethane foam is obtained from the reaction of a polyisocyanate reactant and a polyol reactant in a reaction mixture, and the amount of component (b) is from 0.01 to 2 parts by weight based on 100 parts by weight of the polyol reactant.

9. A composition according to any preceding clause, which comprises additionally
(c) a first further additive.

10. A composition according to clause 9, wherein component (c) is an aromatic amine, a phosphite different to formula I or a phenolic antioxidant.

11. A composition according to clause 10, wherein component (c) is a phenylarylamine with one nitrogen atom, wherein the nitrogen atom is only substituted with a phenyl and an C₆-C₁₀-aryl and the phenyl or the C₆-C₁₀-aryl is alkylated, a phosphite, which is an ester of at least one aliphatic alcohol having at least one primary hydroxyl group, or a phenolic antioxidant, which is an ester of 3-(3,5-ditert-butyl-4-hydroxy-phenyl)propanoic acid or an ester of 3-(3-tert-butyl-4-hydroxy-5-methyl-phenyl)propanoic acid.

12. A composition according to anyone of clauses 9 to 11, which comprises additionally
(d) a second further additive, which is different to the first further additive.

13. A composition according to clause 12, which comprises
(c) a first further additive, and the first further additive is a phenolic antioxidant, and
(d) a second further additive, and the second further additive is an aromatic amine or a phosphite different to formula I.

14. A composition according to clause 13, which comprises
(c) a first further additive, and the first further additive is a phenolic antioxidant, which is an ester of 3-(3,5-ditert-butyl-4-hydroxy-phenyl)propanoic acid or an ester of 3-(3-tertbutyl-4-hydroxy-5-methyl-phenyl)propanoic acid, and
(d) a second further additive, and the second further additive is a phenylarylamine with one nitrogen atom, wherein the nitrogen atom is only substituted with a phenyl and an C₆-C₁₀-aryl and the phenyl or the C₆-C₁₀-aryl is alkylated, or a phosphite, which is an ester of at least one aliphatic alcohol having at least one primary hydroxyl group.

15. A composition according to anyone of clauses 9 to 14, wherein the weight ratio between component (b) and component (c) is from 0.08 to 2.

16. A composition according to anyone of clauses 12 to 15, wherein the weight ratio between component (b) and component (d) is from 0.5 to 2.

17. A process for manufacturing a composition as defined in anyone of clauses 1 to 16, which comprises the step of
(i) incorporating a compound of formula (I) as defined in clause 1 as component (b) into a polyurethane foam as defined in clause 1 as component (a) to obtain the composition.

18. Use of a compound of formula I as defined in clause 1 as component (b) for protecting a polyurethane foam as defined in clause 1 as component (a) against degradation.

19. An additive mixture, which comprises the components
(b) a compound of formula I as defined in clause 1, and
(c) a first further additive, which is a phenylarylamine with one nitrogen atom, wherein the nitrogen atom is only substituted with a phenyl and an C₆-C₁₀-aryl and the phenyl or the C₆-C₁₀-aryl is alkylated.

1. A composition, comprising:
(a) a polyurethane foam or a polyether polyol; and
(b) a compound of formula I 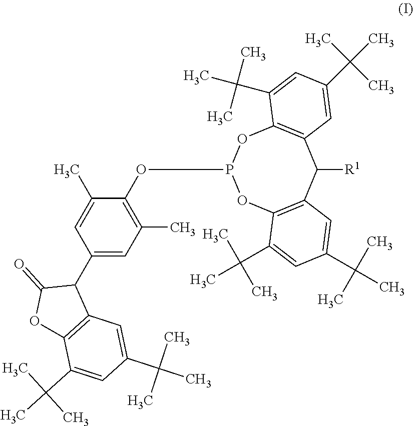
wherein R¹ is H or C₁-alkyl.

2. The composition according to claim 1, wherein at formula I R¹ is C₁-alkyl.

3. The composition according to claim 1, wherein the polyurethane foam is obtained from the reaction of a polyisocyanate reactant and a polyol reactant in a reaction mixture, and 60 to 100 parts by weight of the polyol reactant based on 100 parts by weight of the polyol reactant is a polyether polyol.

4. The composition according to claim 1, wherein the polyurethane foam is obtained from the reaction of a polyisocyanate reactant and a polyol reactant in a reaction mixture, and the reaction mixture contains prior to the reaction water, a carboxylic acid or a blowing agent.

5. The composition according to claim 1, wherein the polyurethane foam has a density between 5 to 500 kg/m³ at 20° C. and 101.3 kPa.

6. The composition according to claim 1, wherein component (a) is a polyurethane foam.

7. The composition according to claim 1, wherein the polyurethane foam is obtained from the reaction of a polyisocyanate reactant and a polyol reactant in a reaction mixture, and the amount of component (b) is in case of the polyurethane foam from 0.01 to 2 parts by weight based on 100 parts by weight of the polyol reactant and in case of a polyether polyol from 0.01 to 2 parts by weight based on 100 parts by weight of the polyether polyol.

8. The composition according to claim 1, further comprising:
(c) a first further additive.

9. The composition according to claim 8, wherein component (c) is an aromatic amine, a phosphite different to formula I or a phenolic antioxidant.

10. The composition according to claim 9, wherein component (c) is a phenylarylamine with one nitrogen atom, wherein the nitrogen atom is only substituted with a phenyl and an C₆-C₁₀-aryl and the phenyl or the C₆-C₁₀-aryl is alkylated, a phosphite, which is an ester of at least one aliphatic alcohol having at least one primary hydroxyl group, or a phenolic antioxidant, which is an ester of 3-(3,5-ditert-butyl-4-hydroxy-phenyl)propanoic acid or an ester of 3-(3-tert-butyl-4-hy-droxy-5-methyl-phenyl)propanoic acid.

11. The composition according to claim 8, further comprising:
(d) a second further additive different to the first further additive.

12. The composition according to claim 11, further comprising:
(c) a first further additive, and the first further additive is a phenolic antioxidant, and
(d) a second further additive, and the second further additive is an aromatic amine or a phosphite different to formula I.

13. The composition according to claim 12, further comprising:
(c) a first further additive, wherein the first further additive is a phenolic antioxidant, which is an ester of 3-(3,5-ditert-butyl-4-hydroxy-phenyl)propanoic acid or an ester of 3-(3-tert-butyl-4-hydroxy-5-methyl-phenyl)propanoic acid, and
(d) a second further additive, wherein the second further additive is a phenylarylamine with one nitrogen atom, wherein the nitrogen atom is only substituted with a phenyl and an C₆-C₁₀-aryl and the phenyl or the C₆-C₁₀-aryl is alkylated, or a phosphite, which is an ester of at least one aliphatic alcohol having at least one primary hydroxyl group.

14. The composition according to claim 8, wherein the weight ratio between component (b) and component (c) is from 0.08 to 2.

15. The composition according to claim 11, wherein the weight ratio between component (b) and component (d) is from 0.5 to 2.

16. A process for manufacturing the composition of claim 1, the process comprising:
(i) incorporating a compound of formula (I) as component (b) into the polyurethane foam or the polyether polyol as component (a) to obtain the composition.

17. A method of using a compound of formula I as component (b) for protecting a polyurethane foam or a polyether polyol as component (a) against degradation, wherein the compound of formula I has the following structure: 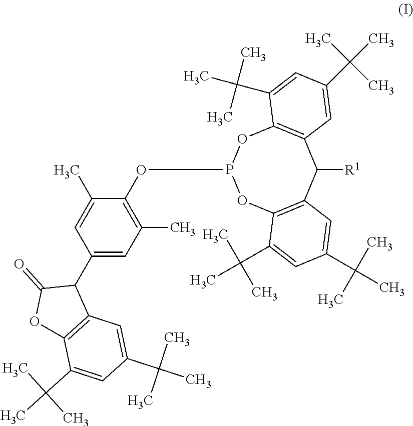
wherein R¹ is H or C₁-alkyl.

18. An additive mixture, comprising:
(b) a compound of formula I 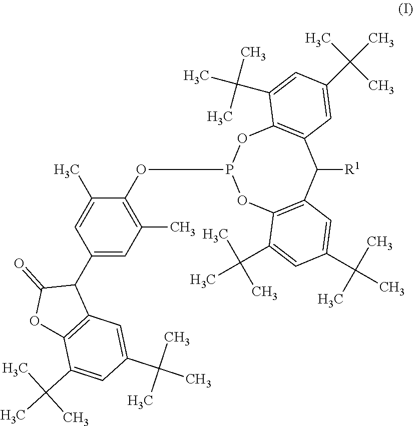
wherein R¹ is H or C₁-alkyl, and
(c) a first further additive comprising a phenylarylamine with one nitrogen atom, wherein the nitrogen atom is only substituted with a phenyl and an C₆-C₁₀-aryl and the phenyl or the C₆-C₁₀-aryl is alkylated.
